(19) United States
(12) Patent Application Publication
(10) Pub. No.: US 2026/0288728 A1
(43) Pub. Date: Sep. 24, 2026

(54) System and method for creating, searching and executing artificial intelligence agents

(71) Applicant: Ram Venkat, Falls Church, VA (US)

(72) Inventor: Ram Venkat, Falls Church, VA (US)

(73) Assignee: Ram Venkat, Falls Church, VA (US)

(21) Appl. No.: 19/693,492

(22) Filed: May 31, 2026

Related U.S. Application Data
(63) Continuation-in-part of application No. 18/963,691, filed on Nov. 28, 2024, now Pat. No. 12,682,000.

(51) Int. Cl. G06F 16/2455; G06F 16/2457; G06F 21/62

(52) U.S. Cl. CPC G06F 16/2455; G06F 16/24578; G06F 21/6227

(57) ABSTRACT

This invention defines a computing platform to create, store and search for artificial intelligence agents in a system domain and execute them in client modules. The invention also defines a machine-readable, textual format for creating agents and describing them to a search engine module in the system domain. Agents are grouped by namespaces in the system domain. Client modules receive search queries, search for agents using the system domain and execute them, which provides search responses or performs actions. A client module is associated with a namespace and can only search and execute agents in its namespace.

### CROSS-REFERENCE TO RELATED APPLICATIONS

This application is a continuation-in-part of U.S. patent application Ser. No. 18/963,691, filed Nov. 28, 2024, the entire contents of which are incorporated herein by reference.

### PRIOR ART

### Application Programming Interface (API)

APIs are mechanisms that enable two or more computer programs to communicate with each other using a set of definitions and protocols. An API provider makes an API available on a server that is accessible from an endpoint. There are many API protocols, the most popular being Hyper Text Transfer Protocol (HTTP), Representation State Transfer (REST), GraphQL, Simple Object Access Protocol, Remote Procedure Call and gRPC.

An API proxy server sits between a client and an API server, providing an access point to the API server with additional functionality such as security, caching, or rate limiting. It can also be used to expose a different interface to the API by changing the protocol, adding or removing headers and parameters.

An API can be public, which is available from anywhere on the internet, or private, which is available only from within an intranet.

### Artificial Intelligence (AI) Models and Techniques

AI models are trained on a set of data to recognize certain patterns.

Large Language Models (LLM) are deep learning models that are trained on vast amounts of data. A pretrained LLM is an LLM that has already been trained on large amounts of data and which is available to ask questions.

LLM fine-tuning involves adapting a pre-trained model to a specific task. Specifically, the LLM is partially retrained using input-output pairs of representative examples of the desired behavior.

Some LLMs like ChatGPT and Anthropic can be called only through an interface over the internet while others like Facebook Llama can be hosted and used from within other systems.

Retrieval-Augmented Generation (RAG) enables language models to incorporate relevant information beyond their training data by prompting them with real-time information from APIs, traditional IT systems, vector database or a full text search engine.

GraphRAG is a RAG, where the retrieval is done from a knowledge graph stored in a graph database.

Retrieval-Interleaved Generation (RIG) is a variation of RAG in which calls to LLMs and traditional IT systems are interleaved.

AI based systems can also use LLMs to query information from traditional IT systems and get a specific task done. Text2SQL is a technology that converts user query in plain English to Structured Query Language (SQL).

### Artificial Intelligence Agent (Agent)

An agent is an application that uses an LLM to decide the flow and output of the application. An agent typically makes one or more calls to LLMs, APIs and other systems to answer a question or perform a task and would be prepared to answer follow-up questions or perform additional tasks. RAGs, GraphRAGs, RIGs, Text2SQL can all be considered as subsets of agents.

### Natural Language Processing (NLP)

NLP is a machine learning technology that gives computers the ability to interpret, manipulate, and comprehend human language.

Named-entity recognition is a field of NLP that locates named entities mentioned in a text into pre-defined entity types. Common entity types recognized are person, location, organization, event, numerical and temporal. Within each entity, there can be several sub-entities like email, Uniform Resource Locator (URL), city, state, quantities, monetary values, percentages and others.

Relation Extraction is the task of extracting semantic relationships between two or more entities in a text.

Both LLMs and NLP libraries can perform named-entity recognition and relationship extraction. Apache OpenNLP and Stanford NLP are popular NLP libraries.

Stop words are commonly used in NLP to filter out some words from processing.

### AI Model Files

A deep learning model file typically contains information about the network architecture, including the number of layers, neurons per layer, activation functions, weights for each connection between neurons, biases, and sometimes additional metadata like training parameters and performance metrics, all structured based on the chosen deep learning framework and often saved in a specific file extension like .h5, which is a Keras file, .pb, which is a TensorFlow file, or .pt, which is a PyTorch file, depending on the framework; essentially capturing the learned state of the model after training. Once a deep learning model is trained, the model file can be uploaded to another computer and be used in an application to make predictions on new data.

### Other Products and Platforms

LangChain is a software framework that helps facilitate the integration of large language models into applications.

No-code LLM app builders allow creating LLM applications by dragging and dropping Graphical User Interface (GUI) elements. Flowwise AI, Langflow and Dify are three such products.

The Hugging Face Hub is a platform with over 900,000 AI models publicly available, on an online platform.

Github is a version control system that allows developers to store, share, and collaborate on the code they create.

Splunk is a software platform that helps users collect, analyze, and visualize large amounts of machine-generated log data.

MySQL is a relational database management system. Cloud-based, relational database services with MySQL are available from Google cloud and Amazon web service.

Amazon Web Service (AWS) S3 and Google cloud storage are popular cloud-based object storage services. An object storage accepts a key and a value. The key is the name of the object. The value is the content of what is being stored, which can be in text or binary format.

An object cache server stores small objects in memory. Popular caching products are Memcached and Redis. AWS offers a cloud caching service called ElastiCache.

Nosql databases are non-relational databases that store data in a flexible, non-tabular format. Cassandra, HBase and MongoDB are popular nosql databases. AWS DynamoDB is a nosql cloud service.

Key-value storage, also known as a key-value database, is a database that links named keys to values of any type. AWS DynamoDB can be used as a key-value storage service.

IP Location database service is offered by multiple companies including Google maps platform and ip2location.com. Using these products, an IP address, zip code, city name or place of interest can be mapped to a location, including city, state, country and local time.

### Full Text Search Service

Two of the most popular full text search engines are Elasticsearch and Apache Solr.

These products provide ways to split text into tokens, add the tokens to a full text search index and expose efficient ways to search the index. Common search ranking algorithms are TF-IDF and BM25.

Many vendors offer cloud-based services for full text search including AWS Opensearch.

### Vector Database Service

A vector database stores text as vector embeddings and allows one to search for text based on similarity. Words, phrases, sentences and paragraphs can be mapped to N dimensional vectors and stored in the database. The process of representing text as an N-dimensional vector, is called vectorization.

An embedding model is used to convert text into an N dimensional vector. The distance between two vectors gives the similarity in meaning between the texts they represent. Common ways to measure vector distances are Euclidean distance, Cosine similarity, Dot product similarity, Manhattan distance and Hamming Similarity.

A vector database service can be created by hosting vector databases like Milvus or interfacing with a cloud vector database service like Pinecone.

### AI Model Hosting Service

There are several vendors that offer a cloud service to host an AI model and provide an endpoint to which clients can send an input and receive an output. Some of them are Hugging Face, Google Colab and Amazon SageMaker.

### Graph Database Service

A knowledge graph is an organized representation of real-world entities and their relationships using nodes and relationships. It is typically stored in a graph database. Entities in a knowledge graph can represent objects, events, situations, or concepts. Neo4j is a popular graph database that can be hosted. Neo4j AuroDB is a hosted graph database service on the cloud.

### Namespace

Namespace is a string with dots separating hierarchical levels, that serves as a label to group and uniquely identify a collection of names or entities within a specific context, ensuring there are no naming conflicts across different scopes.

Formatted String Literals (f-Strings)

F-strings are part of the Python programming language. The concept also exists in other languages like Dart and Java 21. An f-string is a sequence of characters which can contain one or more placeholders. Placeholders start and end with a pair of delimiters and contain an expression in between. Expressions are programming code that are evaluated at program runtime.

### Machine-Readable, Textual Format

Machine-readable textual formats are structured data formats that computers can automatically read and process, while also being easy for a human to read, write and understand. Some examples of machine-readable textual formats include: JavaScript object notation (JSON), extensible Markup Language and Yet Another Markup Language.

### Universally Unique Identifier (UUID)

A UUID, or Universally Unique Identifier, is a 128-bit number that is used to identify information in computer systems. When generated according to the standard methods, UUIDs are, for practical purposes, unique.

### Search Query

A search query contains one or more words that are keywords, operators, a phrase, a full sentence, a question or a directive to perform an action. Typically, they are entered into a textbox on a GUI or uttered verbally to a device.

### BACKGROUND OF THE INVENTION

A machine-readable, textual format to define an agent has many advantages, including being implementation technology agnostic. Such a textual format should support common needs of an agent like calling an LLM, calling an API, control the flow of the program, managing variables, handling errors, techniques for follow up queries, raising events and saving and restoring the state of a running agent.

An end user would not be aware of all the agents that are available for different purposes. They would typically enter a search query and expect an answer, or an action taken. There is a need to have a central computing platform that can store all the agents, match a user's search query to the right agent, execute that agent and provide an answer or perform an action. A technique to describe an agent to a search service is needed so that a search query can be matched to an agent.

A central computing platform as described above can only consume systems and APIs that are either public or private within that central platform. An organization with private systems and APIs on its own intranet cannot use agents that run on the above central platform. Such an organization would need a client component to the central computing platform which can execute agents within its intranet and consume the private systems and APIs that are available only within its intranet.

This invention addresses all the above needs by combining concepts from agents, enterprise search and computer design and architecture that includes a central part and a client part. The fields of this invention are AI, agents, enterprise search, computing platforms and computer design and architecture.

### SUMMARY OF THE INVENTION

A computing platform is defined using a central system domain and distributed client modules. The system domain contains a data storage service, a first LLM service, a search engine module, authentication module, admin module, creation module and an execution module.

Admin users and first users register and login to the system domain using the authentication module. An admin user takes ownership of a namespace and associates an authorization key with the namespace, using the admin module. Admin users also approve first users in the namespace.

First users use the creation module to create agent specifications in that namespace and store them in the data storage service. First users also create agent descriptors, which describe agents to the search engine module. Agent specifications and agent descriptors are specified in a machine-readable, textual format.

Client modules are started anywhere on the internet. Each client module is associated with an authorization key, which associates it with a namespace. Each client module can search and execute agents only in the namespace it is associated with.

A second user sends a search query to a client module, which sends a search request to the execution module. Using the search engine module, the search query is matched to one or more agent names and returned. The client module then retrieves a matched agent's specification from the execution module, creates an agent instance based on the specification and executes the agent instance, which produces a response to the search query or performs an action.

### BRIEF DESCRIPTION OF DRAWINGS

FIG. 1A illustrates an agent in Unified Modelling language (UML).

FIG. 1B illustrates all the commands in an agent in UML.

FIG. 2A illustrates components of the computing platform of this invention.

FIG. 3A illustrates flow of information and actions in the system domain and a client module.

FIG. 4A illustrates a first embodiment of the invention that provides enterprise search solutions.

FIGS. 5A and 5B illustrate a second embodiment of the invention that provides internet search and E-commerce services.

FIG. 6A illustrates a third embodiment of the invention that provides mobile app services.

### DETAILED DESCRIPTION OF THE INVENTION

### System Domain, Client Module and Users

System domain is an internet domain in which this invention maintains its state. The system domain runs the following services and modules:
1. A data storage service
2. A first LLM service
3. Authentication module
4. Admin module
5. Search engine module
6. Creation module
7. Execution module

There would be many client modules and they would be implemented in many languages and platforms. They can be started anywhere on the internet or even within an intranet that runs the system domain. Each client module communicates with the execution module in the system domain, identifying its namespace with an authorization key. Multiple client modules can run with the same authorization key.

Admin users login to the system domain, take ownership of a namespace and approve first users in that namespace. First users login to the system domain, create an agent specification in their namespace and describe them to the search engine module using an agent descriptor. Second users send a search query to a client module and receive a response or an action taken on their behalf.

### Conversation

A conversation is a query thread that includes a first query from a user, one or more second queries from the user, and one or more agent responses associated with those queries.

Each conversation has a conversation identifier (ConvID). When a client module receives a first query without a ConvID, the client module starts a new conversation using the execution module. The execution module creates and maintains the ConvID. A second query that belongs to the same conversation includes the ConvID so that the second query is associated with the same conversation.

A conversation state object is associated with each ConvID. This object is explained in a later section.

### Dynamic Strings

A dynamic string is a string that is enclosed in a pair of designated delimiters. For example, designated delimiters for an evaluated dynamic string can be { . . . }. The content between the braces is evaluated as a language expression within an agent's execution context. The evaluated result replaces the original string value. Although the value is written in an agent specification as a string, the replacement value produced by the evaluated dynamic string can be of any type supported by the implementation language.

When the string is not enclosed within a designated delimiter, the string is not interpreted as code. The value inside the quotation marks is used as written and is interpreted as a constant string value.

Dynamic strings extend the concept of formatted strings by allowing the evaluated expression to return any value supported by the implementation language, rather than always returning a string. For example, a dynamic string can evaluate to a string, number, boolean, list, dictionary, object, asynchronous result, stream-derived value, or another value supported by the implementation language. The expression or code within the designated delimiters can also await asynchronous calls.

Dynamic strings are evaluated using the implementation language associated with the execution module. For example, where Python is used as the implementation language, the expression inside the delimiter is evaluated as a Python expression within the current agent execution context.

The dynamic string concept is not limited to JSON. It can be used in any machine-readable agent specification format in which a string value can be distinguished from other literal values. The examples below use JSON merely as one example representation of an agent specification.

A dynamic string need not be defined directly in an agent specification and may be read from a configuration value, file, database, or other external source.

In some embodiments, an allowlist determines which native-language objects, functions, methods, modules, constants, runtime variables, command results, context objects, and other values are available to dynamic strings. A dynamic string can reference an item only if the item is included in the allowlist or otherwise exposed to the dynamic string by the execution context. Members of objects in the allowlist can also be accessed from a dynamic string, including nested objects, member functions and other nested members to any depth.

The allowlist can include functions and objects that do not permit unauthorized access to system resources. Objects, functions, methods, modules, constants, runtime variables, and other values that are not available under the allowlist are unavailable to the dynamic string, even if they would otherwise exist in the native language runtime.

If a dynamic string references a value that is not available under the allowlist, the execution module may reject the agent during validation.

At runtime, a dynamic string is evaluated within a controlled runtime, in which only the functions and objects in the allowlist are included.

In some embodiments, if the expression evaluates to an awaitable value, the execution module may await the value and use the resolved result as the replacement value. In some embodiments, if a synchronous expression calls a function that returns an awaitable value, the execution module may automatically await the returned value before assigning the result. Dynamic strings may also include asynchronous constructs supported by the implementation language, such as asynchronous comprehensions. When the expression inside the delimiter includes one or more asynchronous calls, the client module may evaluate the expression by placing the expression in an asynchronous function and awaiting execution of the asynchronous function.

Dynamic strings may appear anywhere in an agent specification where a value is permitted.

For example, where Python is the implementation language and JSON is used to represent the agent specification:

```
{
  “greeting”: “Hello, world!”,
  “now”: “{ datetime.now( ).isoformat( ) }”,
  “weather”: “{ f‘{city}: {temperature}’ }”,
  “squares”: “{ [n * n for n in numbers] }”,
  “square_map”: “{ {n: n * n for n in numbers} }”,
  “profile1”: “{ await fetch_url_profile(user_id) }”,
  “profile2”: “{ fetch_user_profile(user_id) }”,
  “lines_from_stream”: “{ [line async for line in stream_lines(url)] }”,
  “usernames_via_parallel_lookup”: “{ asyncio.gather(*(lookup_username(uid) for uid in
  user_ids)) }”
}
```

In the example above, greeting is a constant string value because it is not enclosed within the designated delimiter. The now value is an evaluated dynamic string that calls a date function. The weather value is an evaluated dynamic string that uses a formatted string expression inside the dynamic string. The squares value evaluates to a list, and the square_map value evaluates to a dictionary or mapping object. The profile1 and profile2 values illustrate dynamic strings that can resolve asynchronous results. The lines_from_stream value illustrates an asynchronous comprehension, and the usernames_via_parallel_lookup value illustrates a dynamic string that can evaluate to a parallel asynchronous operation.

The functions, modules, variables, and objects referenced in the example are available only if permitted by the execution context and the applicable allowlist. For example, datetime, fetch_url_profile, fetch_user_profile, stream_lines, asyncio, lookup_username, city, temperature, numbers, url, user_id, and user_ids may be made available to the dynamic strings only when they are included in the allowlist or otherwise exposed by the execution context under the applicable security policy.

### Agent Specification

An agent specification defines an agent in a machine-readable, textual format. This has the following advantages:
1. Client modules can be implemented in any technology or platform
2. Agent specification can be added to a version control system
3. Agent specification can be validated automatically
4. Implementing an approval process for agents is easier as many approval criteria can be automated

An agent specification includes the following fields:
1. Agent name
2. Agent title
3. agentVars unit—specifies a list of variables that are scoped at the agent level
4. An ordered list of task units. Each task unit contains
   a. Task name
   b. Task description—an optional field to describe what the task does
   c. Task args—An optional field that describes the arguments passed to a task unit
   d. An ordered list of command units. A command unit specifies a command that should be run using a command type and a command spec unit. Command spec units can have different fields based on the command type. A command can be one of the following types:
      i. apiClient—Calls an API
      ii. systemLLM—Calls an LLM supported by the system domain
      iii. systemFunction—Calls a function defined in the system domain
      iv. systemQuery—Queries a file uploaded with the upload module
      v. userFunction—Calls a function defined in language packages included with the client module.
      vi. execTask—Executes another task
      vii. conditional—Executes a list of commands based on a condition or in a loop
      viii. codeBlock—Executes a block of code
      ix. followupInputs—Stores information needed to answer further questions.
      x. raiseEvent—Raise an event that would be saved in the system domain
      xi. database—Executes a SQL query on a database
      xii. prompt—set system and user prompt that are used by the systemLLM command.
      xiii. search—search for other agents from a query
      xiv. invoke—Invoke another agent from an agent

In some embodiments, the taskUnits described in this section may be identified in the agent specification as “functions”.

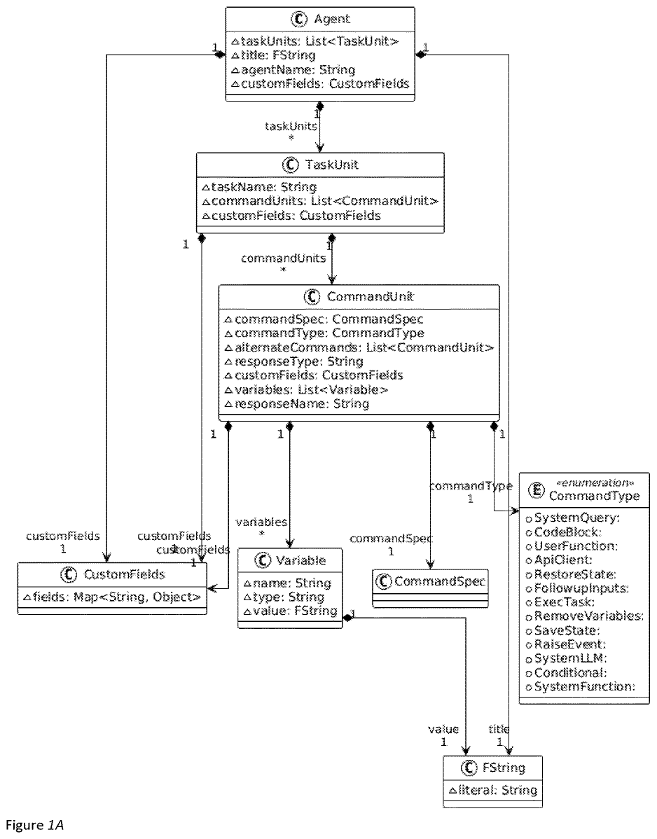

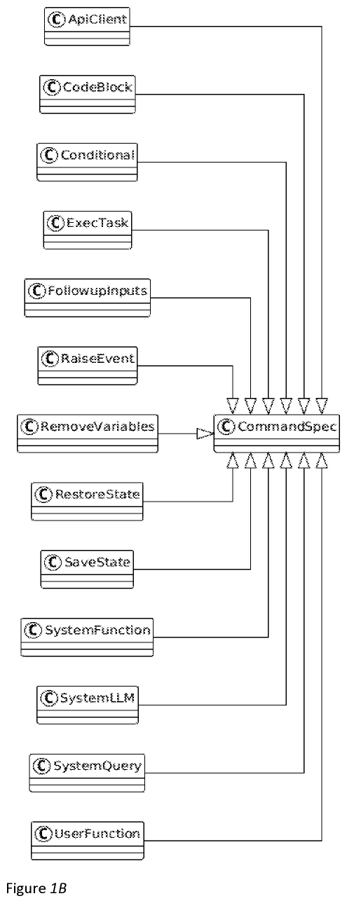

FIG. 1A illustrates an agent specification using a UML class diagram. An agent includes a list of task units. Each task unit includes a list of command units.

In some embodiments, a command unit may be represented as a structured set of fields. The command unit may include one or more command fields, one or more action fields, and one or more variable fields. A command field identifies a command to be executed. In one implementation, a command field is named “command” and includes a command name and one or more parameters associated with the command.

An example of a command field would be:

```
{
  “command”: {
    “name”: “apiClient”,
    “url”: “http://somewhere.com”,
  }
}
```

In some embodiments, a command unit may include multiple command fields. To distinguish multiple command fields within the same command unit, one or more characters may be appended to the command field name, such as one or more spaces, underscores, digits, or other suffix characters. For example, a command unit may include fields named “command”, “command”, “command_”, or “command__”, each of which may be treated as a command field. Each command field may identify a respective command to be executed.

The command name may identify a supported command type, including any of the command types described above. In one implementation, the command name is a value of a name field within the command field. The name field may map to, correspond to, or otherwise identify one of the supported command types.

An action field is a field having a predefined name that causes a corresponding action to be performed by the client module. Action fields may be used for flow control, user or developer information, output streaming, error handling, or other runtime actions. Action fields are described in a separate section below.

In some embodiments, the command unit may include more than one action field of the same type. To distinguish repeated action fields, one or more characters may be appended to the predefined action field name, such as one or more spaces, underscores, digits, or other suffix characters. For example, the command unit may include fields named “trace”, “trace_”, “trace1”, or “trace”, each of which may be treated as a trace action field.

In some embodiments, a variable field may be represented explicitly as a separately identified unit or implicitly by fields of a command unit. For example, any field of the command unit that is not a command field and is not one of the predefined action fields may be treated as a user-defined variable field.

In some embodiments, fields of a command unit are evaluated as they are encountered during execution of the command unit. When the encountered field is a command field, the corresponding command is executed. When the encountered field is an action field, the corresponding action is performed by the client module. When the encountered field is a variable field, the corresponding variable is assigned or updated. Accordingly, the command unit need not include a separately defined ordered variable list, and the execution order may be determined by the order in which fields of the command unit are encountered.

Thus, in some embodiments, command fields identify commands, predefined action field names identify actions by the client module, and remaining field names identify user-defined variables.

An example of a command unit with command fields, action fields and user-defined variables:

```
{
  “trace”: “Starting command api”, // action field
  “command”: { // command field
    “name”: “api”, // command name
    “url”: “https://api.ip2location.io”, // command parameter
  },
  “location”: “{ result }”, // user-defined variable (as it is neither a command field nor an action field)
  “progress”: “{ f‘Got your location: {location[‘region_name’]}’ }”, // action field
},
```

In the above example, trace is an action field because it is one of the known action fields. Action fields are described below. Command is a command field. Location is a user-defined variable because it is neither a command field nor a known action field. Progress is a known action field.

A command unit can also specify a list of alternate commands, which are executed only if there is an error in executing the command.

The following paragraphs discuss each field in the agent specification in more detail.

### Agent Name

An agent name can have only letters, numbers, and hyphens. Second users can bookmark agents and call them directly. Such agent URLs will have the agent name as part of the URL.

In some embodiments, the agent name may be optional within an agent, and may alternatively be included as metadata outside the agent.

### Agent Title

The agent title field is specified as a dynamic string. This is to generate the title dynamically for each search query. The agent title field can be used to show a friendly link to an agent on a second user GUI.

In some embodiments, the agent title field may be optional within an agent, and may alternatively be included as metadata outside the agent.

agentVars Unit

agentVars unit defines variables that are scoped at the agent level. Variables are explained in the variables section below.

### Task Description

Task description is an optional field used to describe what a task unit does. This field is required when a task unit is used in tool calling. Tool calling is described in a separate section below.

### Task Args

Task args is an optional field used to describe each argument to a task unit. This field is required when a task takes arguments and is used in tool calling.

TASK unit

A task unit has a task name that is unique within an agent specification. This allows a task unit to call another task unit by name. A Client module executes an instance of an agent by executing a task that occurs first in its task list. Other tasks in the agent are executed only when they are called from a previous task.

In other embodiments, the task units in an agent may be unordered, and a designated task unit may serve as the starting point for execution of the agent. For example, a task unit named “main” may be required to identify the starting point for agent execution.

### Variables

A variable has a name and a value. A variable can be referenced by a later portion of the agent specification, subject to the scope of the variable.

Variables are assigned values during execution of an agent specification. A value assigned to a variable can be a constant, a dynamic string, or another permitted value. During execution, the assigned value is evaluated or resolved according to its value type, and the resulting value is assigned to the variable.

A field of a command unit that is not a command field and is not a predefined action field can be treated as a variable field. The field name identifies the variable name, and the field value identifies the value to be assigned to the variable.

Each variable field is evaluated when the variable field is encountered during execution of the command unit. Accordingly, the order of variable assignments is determined by the order in which corresponding variable fields are encountered during execution.

A variable can have agent-level scope, task-level scope, or conversation level scope.

An agent-level variable is defined inside an agentVars field at the agent level. Agent-level variables can be read from and written to by any task unit of the same agent. Agent-level variables are persisted when execution of the agent ends. If the same agent is executed again in the same conversation, the persisted agent-level variables can be read from and written to during the later execution. Agent-level variables of one agent are not visible to other agents.

A task-level variable is a variable whose name is first encountered inside a task unit. A task-level variable can be read from and written to within the task unit in which it is first encountered. A task-level variable is not visible outside that task unit, and its value is discarded when execution of the task unit ends.

The client module provides a read only variable called conversationVars. A name-value pair included in conversationVars becomes visible at the conversation level. conversationVars is described below in the Read only variables section.

If a variable name is first encountered in an agentVars field, the variable has agent-level scope. If a variable name is first encountered inside a task unit and is not an agent-level variable, the variable has task-level scope.

The type of a variable is determined dynamically from the value assigned to the variable. The variable need not have a separately declared type.

A variable name can be required to satisfy one or more naming rules. For example, the variable name can be required to comply with Python variable naming rules, can be prohibited from being a Python keyword, and can be prohibited from starting or ending with an underscore. Other implementations can apply different naming rules.

### Read Only Variables

The system can provide a set of predefined read only variables during execution of an agent specification. A read only variable is a variable that may be referenced in an expression, including a dynamic string expression, but cannot be assigned a value by a command unit, task unit, or other part of the agent specification. In some embodiments, validation fails if the agent specification attempts to assign a value to a read only variable.

In some embodiments, the predefined read only variables include, without limitation, inputs, query, ip, result, and conversationVars. Other predefined read only variables may also be provided according to the implementation, execution context, namespace configuration, client module configuration, or agent execution mode.

The inputs variable represents input values passed to the agent. The inputs variable may include values received with a search request, execution request, or other request that causes the agent to execute.

The query variable represents the user input query for the current execution. In some embodiments, query has the same value as inputs [“query”].

The ip variable represents an IP address associated with the user or client that initiated the current execution.

The result variable represents a result produced by the most recently executed command that produces a result. Examples of such commands include an API command, database command, LLM command, search command, and invoke command. When a later command produces another result, the result variable is updated to reference the later result.

The conversationVars variable represents a dictionary or other key-value data structure that holds values scoped at the conversation level. Values included in conversationVars can be referenced by later agent executions associated with the same conversation.

### Alternate Commands

A command can fail for at least two reasons:
1. An apiClient's call to an API server can fail due to network, authorization or quota reached issue.
2. An exception can be raised in a codeBlock command or a dynamic string.
3. An agent runs longer than a maximum time set for that namespace.

Commands in the alternate command list are executed if a command fails.

### Commands in an Agent

FIG. 1B illustrates example commands in UML. Each command may be implemented as a class that derives from a command specification class using object-oriented design techniques. The following paragraphs describe examples of commands that may be included in an agent specification.

The commands shown in FIG. 1B are illustrative and not limiting. In some embodiments, an agent specification may include fewer commands, additional commands, or different combinations of commands. Additional commands may include, for example, a search command, an invoke command, or another command configured to cause the client module to perform a predefined operation. A command may be identified by a command field, a command name, a command type, a class, a schema, or another command identifier.

apiClient Command

An apiClient command makes an API call to a server. It can specify the following fields:
1. protocolType field defines the protocol used to communicate with the API server. Some of the possible values are REST, SOAP, HTTP, graphQL and gRPC. This field will default to REST.
2. protocolSubtype field specifies one of the many ways in which the protocol might be used. For REST protocol, the subtype might be GET or POST. This field will default to GET.
3. endpoint field is the URL where the API service is available. Endpoints are specified as dynamic strings. This is to facilitate:
   a. HTTP GET fields that should be included with the endpoint
   b. Endpoints that are discovered dynamically from responses to previous API calls.
4. headers field specify name-value pairs that are sent as headers in an API request. This can include request types, response types and authorization.
5. parameters field specify name-value pairs that are sent as POST parameters to the API server.
6. responseType defaults to JSON.

A first user can use an API proxy service to hide all the API details and expose a simple REST interface, which can be called from the apiClient command. Function module provides an API proxy service which is explained later.

A first user can also use a secret vault service to hide API authorization keys and not expose them in the agent specification.

In some embodiments, the apiClient command described in this section may be identified in the agent specification by the command name “api”.

systemLLM Command

systemLLM calls a LLM in the system domain with an input and receives an output from the LLM. These calls are sent to the execution module.

A name field in this command specifies the model name of the LLM. Params field specifies the parameters to the LLM. responseType defaults to JSON.

In some embodiments, the systemLLM command can also call a large language model directly from a client module, without using a large language model service in the system domain. In such embodiments, the client module includes one or more large language model adapters that process requests to corresponding large language models.

Each large language model adapter can implement a common adapter interface. The adapter interface can include methods for identifying the adapter, describing the adapter, processing a large language model request, processing a large language model response, and obtaining error information from a response. For example, the adapter interface can include a name method, a description method, a process request method, a process response method, and a get error method.

The client module can provide built-in adapters for one or more large language model providers, such as OpenAI, Gemini, and Anthropic. A developer can also implement a custom adapter that implements the common adapter interface. In this manner, the systemLLM command can support any large language model for which an adapter is provided, including a third-party large language model, a privately hosted large language model, or another large language model accessible to the client module.

In some embodiments, the systemLLM command described in this section may be identified in the agent specification by the command name “μm”.

systemFunction Command

systemFunction executes a function defined in the system domain. These calls are sent to the execution module.

There are two kinds of functions that can be executed:
1. Global functions that are available to all namespaces
2. Namespace specific functions are functions that are available only within a namespace. These are just API proxies defined in the system domain, by a first user.

Examples of global functions are:
1. getLocation—Get location details including a city name, latitude/longitude, zipcode and others from various parameters including an IP address or name of a place of interest, airport code etc.
2. getQueryDetails—Get details of the search query including entity types and values, classifications, filters and patterns matched.

A name field in this command specifies the name of a function. Params field specifies the parameters to the function. responseType defaults to JSON.

systemQuery Command

systemQuery runs a query against a file uploaded from the creation module. These calls are sent to the execution module.

A first user can upload files to the system domain using the creation module and any agent running in the same namespace as the first user can use this command to query the files. The type of files determines the syntax of a query that can be used in this command.

This command can also be used to query files uploaded by the system domain as explained in the creation module section.

A name field in this command specifies the name of an upload. Params field specifies the parameters to the system domain function. responseType defaults to JSON.

userFunction

A client module can include many programming language packages for the execution environment of an agent. Functions in such a language package can be called using a standard interface from the agent.

By default, a client module would include database drivers and other common interface packages and define functions to call various kinds of databases like relational, nosql and bigdata. These can be used to send queries to private systems in the environment that a client module runs.

A name field in this command specifies the name of a user function. Params field specifies the parameters to the user function. responseType defaults to JSON.

execTask Command

An execTask command executes another task by name.

taskName field specifies the name of the other task. This can be left blank to end the execution of the agent.

endThis field specifies whether the current task should end or continue executing after executing the other task.

In some embodiments, the execTask command described in this section may be identified in the agent specification by the command name “func”.

### Conditional Command

A conditional command executes one of two command lists based on the result of evaluating a condition.

‘If’ field specifies a condition to be evaluated. It is specified as a dynamic string, which when evaluated and converted to a boolean value, should be either true or false.

‘then’ field specifies a list of commands to execute, if the ‘if’ condition is evaluated to true.

‘else’ field specifies a list of commands to execute, if the ‘if’ condition is evaluated to false.

Not specifying ‘then’ or ‘else’ block is the same as specifying a list with no commands.

If an additional field ‘loop’ is specified and set to true, the command behaves like a ‘while’ loop in programming languages. The command goes through a repeated process of checking the ‘if’ condition and if that evaluates to true, executing the conditions in the ‘then’ block. When the ‘if’ field evaluates to false, the ‘else’ block is executed and the command ends.

In some embodiments, conditional and loop control may be represented by separate command names instead of a single conditional command with a loop field. For example, an agent specification may include an if command, a while command, a for command, or any combination thereof. These command names may be treated as specialized forms of conditional control flow.

An if command evaluates a condition once. If the condition evaluates to true, the client module executes a first list of commands. If the condition evaluates to false, the client module executes a second list of commands. In some embodiments, the first list of commands is specified using a then field, and the second list of commands is specified using an else field. If either field is omitted, the omitted field is treated as an empty command list.

A while command evaluates a condition before each iteration. While the condition evaluates to true, the client module executes a list of commands specified for the body of the loop. When the condition evaluates to false, execution of the while command ends and the client module continues with the next command after the while command. The condition may be specified as a dynamic string, or another expression supported by the implementation language.

A for command iterates over values produced by an iterable object, collection, mapping, generator expression, query result, command result, or other iterable value. For each iteration, one or more loop variables are bound to values produced by the iterable value, and a list of commands specified for the body of the loop is executed. When the iterable value has no further values, execution of the for command ends and the client module continues with the next command after the for command.

In some embodiments, the for command includes an iter field that identifies the iterable value, a loopVar field that identifies one or more loop variables, and a do field that identifies commands to execute during each iteration. Where the iterable value is a mapping, the loop variables may include a key variable, a value variable, an index variable, or another variable associated with the current iteration. Where the iterable value returns a tuple or other multi-part value, the loopVar field may identify multiple variable names corresponding to the parts of the returned value.

In some embodiments, a loop command may include a maximum-iteration value. The maximum-iteration value limits the number of loop iterations that may be executed. If the maximum number of iterations is reached before the loop otherwise terminates, the client module may terminate the loop, raise an error, terminate the current task, terminate the agent, emit trace information, or take another protective action. The maximum-iteration value may be specified in the command, in a namespace configuration, in an execution configuration, or by the execution module.

codeBlock Command

codeBlock command executes a block of code. The code should be in a programming language that is supported by the client module. Language field specifies the language of the code block.

codeBlock is specified as a dynamic string. The dynamic string is first evaluated into a string and that string is executed as code. This allows the code to be generated dynamically from the output of a previous systemLLM call.

followupInputs Command

followupInputs specify a list of additional inputs needed from a second user to answer a follow up question. For each additional input, a ‘hint’ field can be specified, which a GUI can show to a second user, to solicit an input value. The GUI is expected to send a subsequent call to execute the same agent with a value for each additional input.

A common pattern in agents is a chat-like interface where a second user can ask follow-up questions on the same search query. In that case, an agent can set the search query field name as the additional input required. A second user GUI can show the current answer to the user and also show a widget for a follow up query.

This command can also be used to get an additional input with which an agent can provide a more useful answer to the search query. The additional input can be from a list of values, a text field or a file upload.

followupInputs can specify validation criteria for each additional input. Second user GUI can use the validation criteria to reject values that a second user enters. Validation criteria can be:
1. A list of allowed values for an input value
   a. Second user GUI can use this to show a drop down widget.
2. A regular expression pattern that an input value should match.
3. Length of a text field
4. The size of a file that can be uploaded
5. The type of a file that can be uploaded

In some embodiments, the followupInputs command described in this section may be identified in the agent specification by the command name “ask”.

raiseEvent Command

raiseEvent command sends an event to the execution module in the system domain to record an event. The command takes an eventName and a list of parameter names and values.

### Database Command

The database command executes a SQL statement against a relational database management system.

The database command can use either a database connection profile or a connection string. A database connection profile identifies database connection information defined in a configuration. The profile allows an agent specification to refer to a configured database without hard-coding the database connection string in the agent specification. If a profile is specified, the runtime obtains the corresponding database configuration and uses the connection information associated with that profile.

Alternatively, the database command can include a connection string. The connection string identifies the database driver and database endpoint used to execute the SQL statement. The connection string can identify either a regular database driver or an asynchronous database driver. Examples of regular connection strings include sqlite://, mysql://, postgresql://, oracle://, and mariadb://. Examples of asynchronous driver connection strings include sqlite+aiosqlite://, mysql+aiomysql://, postgresql+asyncpg://, and oracle+oracledb://.

The database command includes a sql field that specifies the SQL statement to execute. The SQL statement can be evaluated dynamically by the runtime before execution. The database command can also include one or more parameters that are passed to the SQL statement. The parameters can be supplied as a dictionary or other key-value structure and can be used by the database driver when executing the SQL statement.

The database command can also include a timeout value. The timeout value specifies a maximum amount of time, in seconds, for execution of the SQL statement. If the SQL statement does not complete within the timeout period, the database command can fail or return an error.

During execution, the runtime determines whether a database profile has been specified. If a profile is specified, the runtime retrieves the profile from a database service. If the profile is not found, the runtime raises an error indicating that the database profile is unknown. If no profile is specified, the runtime obtains the connection string from the database command. If neither a profile nor a connection string is specified, the runtime raises an error indicating that one of them must be provided.

After the connection information is determined, the runtime evaluates the SQL statement, evaluates any SQL parameters, and evaluates the timeout value. The runtime then executes the SQL statement using a database connection manager. The database connection manager can use a connection pool associated with the profile, or it can establish or reuse a connection based on the connection string. The result of the database command is a set of rows returned by the SQL statement. The rows can be returned as JSON-compatible values and assigned to a runtime variable or otherwise used by later command objects.

The database command can be used with relational databases such as MySQL, PostgreSQL, Oracle, SQLite, and MariaDB.

### Example

```
{
  “command”: {
    “name”: “database”,
    “profile”: “ordersDatabase”,
    “sql”: “select id, status, total from orders where user_id = :user_id”,
    “params”: {
      “user_id”: “{userid}”
  },
  “timeout”: 30
  },
  “orders”: “{result}”
}
```

In this example, the database command uses the ordersDatabase profile to obtain database connection information. The SQL statement selects order information for a user. The user_id parameter is supplied dynamically, and the rows returned by the database command are assigned to the orders variable.

In some embodiments, the database command described in this section may be identified in the agent specification by the command name “db”.

prompt

The prompt command defines or modifies a prompt object that is consumed by a systemLLM command. A prompt object is a persistent, named object associated with a conversation. The prompt object is stored in the conversation state object and persists for the duration of the conversation.

A prompt object provides the mechanism for maintaining short-term conversational memory for a large language model. Large language models are stateless in that each model request is processed as a new request unless prior context is included in the request. The prompt object reconstructs, accumulates, and provides relevant prior conversational context to the large language model in a subsequent ‘llm’ request.

An agent can define one or more prompt objects. Each prompt object has a name. A systemLLM command selects which prompt object to use by referencing the prompt object's name. If no name is specified, the prompt object is named “default”. Most agents use a single prompt object and therefore omit the prompt name in both the prompt command and the systemLLM command.

The system parameter defines a system prompt to a systemLLM command. The system prompt can include role instructions, behavioral instructions, formatting instructions, tool-use instructions, constraints, or other directives provided to the large language model. The semantics of the system prompt are determined by the underlying large language model vendor, model, adapter, or application programming interface. When this parameter is set, it replaces whatever value that already exists in the system parameter.

The user parameter defines user prompt to a systemLLM command. Each time the user parameter is set, its value is appended to the existing prompt object as user prompt content. Repeated executions of the prompt command therefore build prompt history rather than replacing prior user prompt content.

A prompt object includes an ordered list of prompt elements. The prompt elements include user entries, assistant responses, and tool results. A user entry includes one or more content parts, such as text content or image content. An assistant response includes content generated by the large language model or one or more tool calls requested by the large language model. A tool result element includes one or more results returned by tools that were called during execution of the systemLLM command.

When a systemLLM command consumes a prompt object, the ordered prompt elements are assembled into the request sent to the large language model. When the large language model returns an assistant response, the assistant response is added to the prompt object. When the large language model requests execution of one or more tools, the tool calls and corresponding tool results are also added to the prompt object. In this manner, the prompt object maintains the interaction history among the agent, the large language model, and tools used by the large language model.

Prompts also provide the mechanism through which multiple agents work together in a conversation. For a first user query, a first agent can use the default prompt object, add user prompt content, invoke a systemLLM command, and produce a first answer. The prompt object, including the input to the large language model and the output from the large language model, is saved in the conversation state object. A later user query in the same conversation can be matched to a second agent. When the second agent executes using the same prompt object, its user parameter is appended to that prompt object. A subsequent llm request therefore includes prompt content produced by both the first agent and the second agent. This allows multiple agents to contribute to a shared conversational context while executing separately.

During validation, debugging, tracing, or execution, the fully assembled prompt structure sent to the large language model is available in trace output. The trace output allows a developer to inspect how the values defined by the prompt command are combined with assistant responses, tool calls, tool results, and other prompt elements before the ‘llm’ request is made.

### Example

```
{
  “command”: {
    “name”: “prompt”,
    “system”: “You are a great philosopher.
    Give a philosophical answer to the question.”,
    “user”: “{ query }”
  }
}
```

In this example, the prompt command defines the default prompt object because no prompt name is specified. The system parameter provides instructions to the large language model. The user parameter appends the value of the query variable to the prompt object as user prompt content. A later systemLLM command consumes the default prompt object when making a request to the large language model.

### Search Command

A search command searches for agents that match a query. The search command uses the same agent-search functionality that is used by the search engine module to match a user query to one or more agents.

The search command includes a query parameter. The query parameter specifies the query to be matched against available agents. The query may be a natural-language query.

The search command may also include a tags parameter. The tags parameter restricts the search to agents that have matching tags. If the tags parameter is not specified, or is empty, the search is performed without restricting the results by tags. Tags are described in a separate section below.

After the search command is executed, the result variable contains the search results. The result variable is read-only. The search results are stored as a list. Each entry in the list identifies a matching agent. In one embodiment, each entry includes an agentName field, an agentTitle field, and an agentVersion field.

The search results are ordered by search relevance. The best matching agent appears first in the list.

The following is an example of a search command:

```
{
  “command”: {
      “name”: “search”,
      “query”: “Can I go for a walk now?”,
      “tags”: “default”
    }
}
```

In this example, the result variable may contain the following value:

```
[
  {
    “agentName”: “weather”,
    “agentTitle”: “Answer weather related questions”,
    “agentVersion”: 1767636413
  },
  {
    “agentName”: “calendar”,
    “agentTitle”: “Answers questions on calendar appointments”,
    “agentVersion”: 1767463817
  }
]
```

In this example, the weather agent is the highest-ranked matching agent, and the calendar agent is the next highest-ranked matching agent. The response also includes the latest version number of the agent.

### Invoke Command

An invoke command executes another agent. The invoke command may be used by one agent to call another agent.

The invoke command includes an agent parameter. The agent parameter specifies the name of the agent to invoke.

The invoke command may also include a query parameter. The query parameter specifies the query that is passed to the invoked agent. If the query parameter is not specified, the invoked agent may execute without a forwarded query or may use the current query being processed by the calling agent.

The invoke command may also include a version parameter. The version parameter specifies the version of the agent to invoke. In some cases, the version parameter may be obtained from a previous search command. If the version parameter is not specified, the client module may invoke a cached older version or fetch the current version from the execution module.

The invoked agent executes within the same context as the calling agent. For example, the invoked agent may execute as part of the same conversation and may have access to the conversation state object available to the calling agent.

Output produced by the invoked agent is streamed to the user interface. From the user's perspective, the output may appear as output of the calling agent.

After the invoke command is executed, the result variable contains the value returned by the main function of the invoked agent. The result variable is read-only.

The following is an example of an invoke command:

```
{
  “command”: {
    “name”: “invoke”,
    “agentName”: “weather”
  }
}
```

In this example, the weather agent is invoked by the calling agent.

### Action Fields

In some embodiments, a command object may include one or more action fields. An action field is a predefined field that causes the client module to perform an action.

Examples of action fields include the following:
break: terminates a current loop.
continue: skips to a next iteration of a current loop.
return: returns from a current function, task, or other execution scope.
end: terminates execution of the agent successfully.
fail: terminates execution of the agent with an error.
progress: displays a progress message to an end user.
trace: emits execution trace information for developer diagnostics. This is used by agent developers and does not show the trace information to the end user.
log: writes a local log message in an application server environment. In some embodiments, log messages are not sent to a cloud service.
output: streams or otherwise provides an output part generated by the agent.

In some embodiments, a command object may include multiple action fields. If an action field needs to be repeated within the same command object, one or more trailing spaces, underscores, digits, or other suffix characters may be added to the action field name. For example, “trace,” “trace_,” “trace1,” and “trace” may each be interpreted as a trace action field.

In some embodiments, agent output is produced by assigning a value to the output action field. Each assignment to the output action field may be streamed to a user interface as an output part. Output parts may be append-only and may preserve the order in which they are produced. Supported output parts may include text, HTML, image data, output generated by a large language model, or other content.

A text output part may be interpreted as Markdown. Text may be specified using a structured object, such as:

```
{
  “output”: {
    “type”: “text”,
    “data”: “The answer to your question is **42**”
  }
}
```

Text may also be specified by assigning a string directly to the output action field:

{
“output”: “The answer to your question is **42**”
}

An HTML output part may be rendered as HTML. In some embodiments, the HTML is cleaned or sanitized before rendering, and Markdown processing is not applied.

```
{
  “output”: {
    “type”: “html”,
    “data”: “The answer to your question is <b>42</b>”
  }
}
```

An image output part may include base64-encoded image data and an explicit MIME type.

```
  {
  “output”: {
    “type”: “image”,
    “mimeType”: “image/png”,
    “data”: “iVBORw0KGgoAAAANSUhEUgAAAZAAAAGQCAYAAACAvzbMAAAB...”
  }
}
```

In some embodiments, the result of a large language model command may be passed directly to the output action field. For example:

```
{
  “command”: {
    “name”: “systemLLM”
  },
  “output”: “{ result }”
  }
```

If the large language model command produces a streaming response, the output action field may cause the streaming response to be forwarded to the user interface as it is received.

In some embodiments, result is a read-only variable containing the large language model response. When assigned to the output action field, client module may convert the response to a multipart output format and stream it to the user interface.

### Tool Calling

In some embodiments, an agent may use a large language model command to perform tool calling. Tool calling allows a large language model to request execution of one or more tools during generation of a response. A tool may include, for example, a task unit defined in the agent specification, a tool provided by a large language model vendor, a tool provided by a configured Model Context Protocol (MCP) server, an application programming interface, a search service, a database service, a file service, or another executable service that can provide information or perform an operation for use by the large language model.

In some embodiments, the large language model command may support tool calling using task units defined within the agent specification. Each task unit has a name. A task unit that is available for tool calling may also include a description, one or more arguments, and a type for each argument. The large language model command may include a functions field that identifies one or more tools that are available to the large language model. When a task unit is made available as a tool, the name of the task unit may be included in the functions field. The client module may use the name included in the functions field to locate the corresponding task unit, and may use the description, arguments, and argument types of the task unit to generate a tool definition for the large language model.

In some embodiments, the functions field may also identify one or more tools provided by a large language model vendor. For example, a large language model vendor may provide an Internet search tool, a code execution tool, a file search tool, or another hosted tool. A hosted vendor tool identified in the functions field may be made available to the large language model along with any task units identified in the functions field. In some cases, the large language model vendor may execute the hosted vendor tool without returning a tool call to the client module. In other cases, the vendor may return information about the tool use or tool result to the client module according to a vendor-specific mechanism.

When the large language model determines that a tool should be used, the large language model may return a tool call. The tool call may identify a tool and may include one or more arguments for the tool. If the tool call identifies a task unit, the client module receives the tool call, identifies the corresponding task unit, invokes the task unit with the arguments included in the tool call, executes the task unit, and returns the task unit result to the large language model. If the tool call identifies a hosted vendor tool and the tool call is returned to the client module, the client module may process the tool call in a manner required by the large language model vendor, receive or obtain a tool result, and provide the tool result to the large language model. The large language model may then continue generation using the returned result. The large language model may return additional tool calls before generating a final response.

For example, the following systemLLM command exposes three task units as callable tools:

```
{
  ″command″: {
    ″name″: ″systemLLM″,
    ″functions″: [
      ″getMyIP″,
      ″getLocation″,
      ″getWeather″
    ]
  },
″output″: ″{ result }″
}
```

In the above example, the task units named getMyIP, getLocation, and getWeather are exposed to the large language model as callable tools. During execution, the large language model may determine that the user query requires local weather information and may return a tool call identifying the getMyIP task unit. The client module receives the tool call, identifies the corresponding task unit, invokes the getMyIP task unit, and provides the returned IP address to the large language model. The large language model may then return a second tool call identifying the getLocation task unit and including the IP address, or information derived from the IP address, as an argument. The client module invokes the getLocation task unit with the specified argument and provides the returned location information to the large language model. The large language model may then return a further tool call identifying the getWeather task unit and including location information as one or more arguments. The client module invokes the getWeather task unit with the specified arguments and provides the returned weather information to the large language model. The large language model may then generate a response using the weather information returned by the task units. This process may be repeated for multiple tool calls before the large language model generates a final response.

A task unit exposed as a tool may be executed in the same manner as other task units, except that execution is initiated in response to a tool call returned by the large language model.

In some embodiments, the client module may include an MCP client for communicating with one or more configured Model Context Protocol (MCP) servers. An MCP server may expose one or more external tools. The large language model command may include an mcp field identifying one or more tools provided by one or more configured MCP servers. The client module may use the mcp field to determine which MCP tools are made available to the large language model for tool calling. For example, the following systemLLM command exposes an MCP tool as a callable tool:

```
{
  ″command″: {
    ″name″: ″systemLLM″,
    ″mcp″: [
      ″hf.hub_repo_search″
    ]
  },
  ″output″: ″{ result }″
}
```

In the above example, the value hf.hub_repo_search identifies a tool exposed by a configured MCP server. The portion hf identifies an MCP server that has been configured in the client module. The portion hub_repo_search identifies a tool provided by that MCP server. During execution, the large language model may return a tool call identifying the MCP tool. The client module receives the tool call, determines that the tool call corresponds to the hub_repo_search tool of the hf MCP server, uses the MCP client to send the tool call to the configured hf MCP server, receives a tool result from the MCP server, and provides the tool result to the large language model. The large language model may then use the tool result to generate a response or to return one or more additional tool calls.

In some embodiments, the configuration for an MCP server may be stored separately from the agent specification. The configuration may include, for example, a server address, authentication information, available tool definitions, transport information, or other information used to communicate with the MCP server. For example, when an agent specification identifies an MCP tool using a server name and tool name, the client module may use the server name to locate the configuration for the MCP server. Configurations are described in a separate section.

In some embodiments, tool calling using agent-defined task units, vendor-provided tools, and MCP tools may be used separately or together. For example, a large language model command may expose one or more local task units, one or more vendor-provided tools, one or more MCP tools, or any combination thereof. The client module may provide the available tool definitions to the large language model, receive one or more tool calls from the large language model, execute or process each requested tool call through the appropriate mechanism, and return corresponding tool results to the large language model when required. A tool call identifying a local task unit may cause the client module to invoke the corresponding task unit of the agent. A tool call identifying a vendor-provided tool may be handled using a mechanism provided by the large language model vendor. A tool call identifying an MCP tool may cause the client module to use the MCP client to communicate with the corresponding MCP server.

### Conversation State Object

A conversation state object is an object associated with a conversation and persisted in the system domain. The conversation state object is created and managed by the client module and stored in the data storage service by calling the execution module. The conversation state object is associated with the ConvID for the conversation. The conversation state object includes agent run records, prompt objects, conversation variables, and agent variables. The conversation state object also includes additional input information when an agent run pauses to request additional information from a user.

An agent run record is a record of one execution of an agent in a conversation. Each time an agent executes in a conversation, the client module creates an agent run record for that execution. The agent run record includes an agent name, an agent version, a call stack, inputs provided to the agent, output produced by the agent, a time of execution, and additional input information if execution pauses to request additional information from a user.

The conversation state object stores a list of agent run records. The list of agent run records can include executions of the same agent or executions of different agents in the same conversation. By storing agent run records in the conversation state object, the client module records which agents have executed in the conversation, which versions of those agents executed, what inputs were provided to those agents, what outputs were produced by those agents, when the agents executed, and what call stack existed during execution.

The output stored in an agent run record includes output generated by the agent. The output includes an agent name and one or more content parts. The agent name in the output is used for presenting the output in a user interface. The content parts include text content, HTML content, image content, another MIME type, or another type of content generated by the agent for presentation to a user.

The prompt objects stored in the conversation state object are the prompt objects described above with respect to the prompt command. The conversation state object can store one or more prompt objects. Each prompt object can be identified by a prompt name. A default prompt object can be used when no prompt name is specified. The prompt objects are restored as part of the conversation state object when a later user query is processed in the same conversation.

A prompt object stored in the conversation state object can be created or updated by one agent and later used by the same agent or a different agent in the same conversation. For example, a first agent can update a prompt object during execution for a first user query. A second agent can later be selected for a second user query in the same conversation and can construct a language model request using the same prompt object. In this manner, the prompt objects stored in the conversation state object allow language model requests to include conversational context accumulated during the conversation.

Conversation variables are stored in the conversationVars field of the conversation state object. The conversationVars field stores key-value pairs that are shared at the conversation level and can be used by the same agent or by different agents executed in the conversation.

Agent variables are stored in the agentVars field of the conversation state object. The agentVars field stores variables separately for different agents. In some embodiments, agentVars is a mapping from an agent name to a dictionary of key-value pairs for that agent. When an agent runs again in the same conversation, the agent can use the key-value pairs stored for that agent in the conversation state object.

Conversation variables are shared across agents in the conversation. Agent variables are stored separately for each agent that executes in the conversation. Thus, prompt objects and conversation variables provide shared conversation-level information, while agent variables provide separate agent-level information for each agent.

Additional input information is information stored in the conversation state object when execution of an agent pauses to request additional information from a user. The additional input information includes a message for presentation to a user and one or more input definitions. Each input definition includes a name used to identify a value received from a user, an input type, a label, a description, selectable options, a default value, and an indication of whether the input is hidden from a user.

The input type identifies the type of input requested from a user. The input type can include a string input, password input, text input, single-choice input, multiple-choice input, or another input type. For single-choice and multiple-choice inputs, the input definition can include options from which a user can choose. A hidden input is sent back from a user interface without being shown to a user.

When additional input information is stored in the conversation state object and later input is received from a user, an agent uses the additional input information during execution. The agent can compare the received input with the stored additional input information and validate each received value based on the corresponding input definition. For example, the agent can validate that a received value is provided for a requested input name, that the received value corresponds to the requested input type, and that the received value is one of the selectable options when the input type requires selection from a set of options. After validation, the agent can associate the received values with the corresponding input names and use the received values to resume or continue execution.

The call stack stored in an agent run record allows execution to continue after an agent pauses to request additional information. For example, a first agent can call a second agent, and the second agent can pause to request additional information from a user. In that case, the conversation state object stores the call stack and the additional input information. When a user provides the requested additional information, the client module restores the calling agent and provides the restored conversation state object and the additional user input to the calling agent. The calling agent uses the call stack to determine where execution paused and which agent to call with the additional user input. The calling agent can then continue execution by calling the appropriate agent with the additional user input and continuing from the point identified by the call stack.

When an agent completes successfully or pauses to request additional information from a user, the client module encrypts the conversation state object and sends it to the execution module, which stores the conversation state object in the data storage service. The conversation state object is stored in the system domain. The conversation state object is not stored when execution of the agent fails.

The encryption key used to encrypt the conversation state object can be provided by the system domain or by the client module. When the encryption key is provided by the system domain, the system domain can provide key management for stored conversation state objects. When the encryption key is provided by the client module and is not made available to the system domain, the conversation state object is end-to-end encrypted so that the contents of the conversation state object are not readable in the system domain.

When a follow-up user query is received in the conversation, the client module retrieves the conversation state object associated with the conversation identifier from the execution module before executing an agent for the follow-up user query. Retrieving the conversation state object includes retrieving the stored conversation state object from the system domain and decrypting the conversation state object. If the follow-up user query does not identify an agent, the client module matches the follow-up user query to an agent and runs the matched agent. If the follow-up user query identifies an agent, the client module runs the identified agent against the follow-up user query and any additional input received from a user.

The agent that executes for the follow-up user query uses the restored conversation state object. The restored conversation state object includes the agent run records, prompt objects, conversation variables, agent variables, additional input information, or any combination thereof. The restored conversation state object can be used by the agent to construct a language model request, evaluate expressions, provide variable values, determine prior outputs or prior inputs, resume a paused execution, avoid repeating a previously completed operation, or otherwise continue the conversation. During execution, the agent can update the conversation state object by updating prompt objects, creating or updating conversation variables, creating or updating agent variables, adding an agent run record, storing output, storing additional input information, or performing another state-changing operation. When the execution completes successfully or pauses for additional information, the updated conversation state object is encrypted by the client module and stored in the system domain for use in a later portion of the conversation.

The client module can request a conversation state object using the conversation identifier. The conversation state object received in response to the request includes information associated with that conversation, including agent run records, prompt objects, conversation variables, agent variables, additional input information, or any combination thereof. The client module can use the received conversation state object to present the conversation in a user interface, including prior user queries, agent outputs, language model responses, tool results, or other information from the conversation. A user can continue the conversation from the user interface by submitting a follow-up user query associated with the same conversation identifier.

### Multiple Agents in a Conversation

Multiple agents can contribute to the same conversation without being coded to know about each other. A first user query can be matched to a first agent. A follow-up user query in the same conversation can be matched to a second agent. The matching can occur dynamically based on the query, agent metadata, search results, routing logic, or another matching technique.

The agents remain independent. The first agent does not need to identify, call, or configure the second agent. The second agent does not need to identify, call, or configure the first agent. The agents nevertheless cooperate because they use conversation-level state.

A prompt object is associated with the conversation and stored in the conversation state object. When the first agent responds to the first user query, the first agent adds context for the first query to the prompt object and uses the prompt object in a systemLLM command to generate a first answer. The updated prompt object is stored as part of the conversation state object, which is stored in the data storage service when the agent completes successfully.

When the follow-up user query is later received, the conversation state object is restored from the data storage service. The second agent uses the same prompt object from the restored conversation state object. The second agent adds context for the follow-up user query to the prompt object and uses the prompt object in a systemLLM command to generate a second answer. Because the prompt object already includes context and output from the first agent, the large language model can use information from both agent executions when generating the second answer.

The agents can also use conversation variables stored in the conversation state object. For example, the first agent can authenticate a user and store an authenticated user identifier, session identifier, access token, or other authentication state as a conversation variable. When the second agent executes later in the same conversation, the second agent can read the conversation variables from the restored conversation state object. If the second agent finds valid authentication state in the conversation variables, the second agent can use that authentication state instead of unnecessarily authenticating the user again. In this manner, independent agents can share operational state through the conversation state object while still maintaining separate agent-level state.

### Example

Initial user query: How many vacation days do I have left, and what is the policy for carrying unused vacation into next year?
Matched agent: Workforce Policy Agent
First answer: You have 9 vacation days left. Company policy allows up to 5 unused vacation days to carry into the next year, so you should plan to use at least 4 days before year-end.
Follow-up user query: What should my manager consider when planning the team's Q4 contractor budget?
Matched agent: Finance and Procurement Policy Agent
Second answer: Since 4 of your vacation days may be lost if unused, your manager should assume you may take time off before year-end. For Q4 planning, the team may need short-term contractor coverage. Contractor spend should be assigned to the correct cost center and approved through the purchase request process before work begins.

In this example, the Workforce Policy Agent and the Finance and Procurement Policy Agent are independent agents. They are not coded to know about each other. The first query dynamically matches the Workforce Policy Agent, and the follow-up query dynamically matches the Finance and Procurement Policy Agent. The second answer nevertheless uses information produced during execution of the first agent because both agents use the same prompt object stored in the conversation state object.

### Conversation State Object Lifecycle

In some embodiments, a client module owns and controls a conversation state object. A data storage service in the system domain stores and retrieves conversation state objects, but does not control their contents during agent execution. The conversation state object can be encrypted as described in the Conversation State Object section.

When the client module executes an agent in response to a query from a second user, and the query is not accompanied by a ConvID, the client module creates a new conversation state object. This creation begins the lifecycle of the conversation state object. A ConvID corresponding to the new conversation state object can be created by the execution module or by the client module. The new ConvID is associated with the second user from whom the query was received.

The newly created conversation state object is used during execution of the agent. During agent execution, values can be included in, updated in, or removed from the conversation state object as described in the Conversation state object section.

When execution of the agent completes successfully, or when execution pauses to request additional input, the client module causes the conversation state object to be stored in the data storage service. The conversation state object is stored using the ConvID as a key. In some embodiments, the client module stores the conversation state object by sending the conversation state object and the ConvID to the execution module, and the execution module stores the conversation state object in the data storage service.

When the client module later receives a second query, a follow-up query, or a response to the requested additional input, the query is accompanied by the ConvID. The client module uses the ConvID to restore the stored conversation state object from the data storage service through the execution module. The restored conversation state object is then used during the next execution of the agent.

When that execution completes successfully, or again pauses to request additional input, the client module causes the updated conversation state object to be stored in the data storage service using the same ConvID. The stored conversation state object can overwrite the previously stored conversation state object for that ConvID. This process can repeat for additional queries in the same conversation.

In some embodiments, the execution module stores, for each second user, a list of ConvIDs associated with that second user. The execution module can also store metadata associated with each ConvID, including a first query in the conversation, a most recent query in the conversation, and a last-used time for the conversation. The metadata can be encrypted. The client module can request the list of ConvIDs and associated metadata for a second user to display a list of conversations to the second user.

When the second user selects one of the displayed conversations, the client module can request the conversation state object associated with the selected ConvID. After the conversation state object is restored, the second user can view the corresponding conversation and continue the conversation by submitting a follow-up query.

In some embodiments, the system domain deletes a conversation state object based on recency of usage, including when the conversation state object was last restored, last fetched, or last stored. The client module can also request deletion of a conversation state object by providing the corresponding ConvID.

When the conversation state object is deleted, the lifecycle of the conversation state object ends.

### Groups and Tags

In some embodiments, agents may be associated with one or more groups, one or more tags, or both. Groups and tags may be used to control which agents are available in response to a search, selection, invocation, or execution request.

### Groups

A group is an access-control attribute associated with an agent. A group may identify a class of end users, accounts, organizations, tenants, roles, subscriptions, permissions, or other access categories that are permitted to discover, select, invoke, or execute the agent.

In some embodiments, when an end user searches for or attempts to execute an agent, the search engine module compares one or more groups associated with the agent with one or more groups associated with the end user. If the end user is not associated with a required group, the agent may be omitted from search results, hidden from the end user, or prevented from being executed by the end user.

In some embodiments, group-based restrictions apply to end users but not to developers, administrators, owners, or other privileged users. For example, a developer may be permitted to search for, test, invoke, or execute agents regardless of whether the developer belongs to a group associated with the agent.

### Tags

A tag is a classification attribute associated with an agent. A tag may identify a category, capability, subject matter, domain, function, use case, data source, tool type, language, version, deployment status, or other descriptive characteristic of the agent.

In some embodiments, tags may be used to filter, rank, organize, search for, or display agents. For example, a search request may specify one or more tags, and the search engine module may return agents associated with those tags. Tags may also be used by an orchestrator, search command, routing process, or user interface to identify agents that are relevant to a user query or task.

Unlike groups, tags need not define access-control restrictions. In some embodiments, tags categorize agents for discovery or routing, while groups restrict access to agents based on the identity, role, permissions, or other attributes of the end user.

### Configuration

In some embodiments, the computing platform includes one or more configuration objects that externalize settings used by agents during execution. A configuration object may define reusable settings for an API, database, prompt, large language model, or other system resource. By storing these settings outside the agent specification, the agent specification can refer to a named configuration object instead of hard coding connection details, authentication headers, model settings, prompt text, or other resource-specific information.

An API configuration defines a reusable API endpoint or API server. The API configuration may include a name, a server URL, default HTTP method, HTTP headers, authentication headers, timeout settings, connection pool settings, maximum connections, maximum keep-alive connections, and keep-alive expiration settings. An agent using an apiClient command may identify the API configuration by name. The apiClient command may then use the URL, headers, method, timeout settings, and connection pool settings from the named API configuration. The agent specification therefore need not include the full API definition in each command that calls the API.

In some embodiments, an API configuration may also restrict what an agent is permitted to override. For example, authentication headers or a base URL may be defined in the API configuration and may not be modifiable by the agent. Other request-specific values, such as a path, query parameter, request body, or method, may be supplied by the agent if permitted by the configuration.

A database configuration defines a reusable database connection. The database configuration may include a name, connection string, transaction isolation level, pool size, pool timeout, pool recycle setting, pre-ping setting, maximum overflow setting, and driver-specific connection arguments. An agent using a database command may identify the database configuration by name. The database command may then use the connection string and connection pool settings from the named database configuration. The agent specification therefore need not include the database connection string or other database connection details.

In some embodiments, when a database configuration includes a connection string, the agent is not permitted to override the connection string. This allows database credentials and database routing information to be centrally administered while still allowing an agent to specify a query, parameters, result variable, or other command-level database behavior.

A prompt configuration defines a reusable prompt profile. The prompt configuration may include a name, system prompt text, user prompt text, or both. An agent using a prompt command may identify the prompt configuration by name. The prompt command may then initialize or update a prompt object using the system prompt and user prompt from the named prompt configuration. The agent specification therefore need not repeat standard prompt text across multiple agents.

In some embodiments, a prompt configuration may be used to provide a common system prompt for a namespace, tenant, application, agent family, or use case. The agent may add additional user prompt text or context during execution. Where multiple user prompt values are supplied during a conversation or during a call to a large language model, the user prompt values may be combined according to the prompt command behavior.

An LLM configuration defines a reusable large language model profile. The LLM configuration may include a name, vendor identifier, adapter identifier, LLM server URL, HTTP headers, additional request parameters, allowed models, default model, maximum token limit, retry count, connection pool settings, maximum number of tools, maximum number of tool calls, and a tool error prompt. An agent using a systemLLM command may identify the LLM configuration by name. The systemLLM command may then use the vendor, adapter, URL, headers, model restrictions, token limits, retry settings, tool limits, and other parameters from the named LLM configuration.

In some embodiments, the LLM configuration identifies an adapter class for communicating with a particular LLM vendor or LLM service. The adapter converts the command-level request into a vendor-specific request and converts the vendor-specific response into a system response. Additional parameters in the LLM configuration may be merged with parameters produced by the adapter. If there is a discrepancy, the configuration-defined additional parameter may override the adapter-produced parameter.

The LLM configuration may also restrict agent behavior. For example, the configuration may define a list of allowed models and a default model. If the agent does not specify a model, the default model is used. If the agent specifies a model, the specified model must be one of the allowed models. The configuration may also define a maximum token limit. An agent may set a lower limit for a particular call, but may not exceed the maximum token limit defined by the configuration.

The LLM configuration may further define limits for tool calling. For example, the configuration may define a maximum number of tools that may be provided to a large language model call and a maximum number of tool call iterations that may be performed. The configuration may also define a tool error prompt that is provided to the large language model when a tool call returns an error.

Configuration objects may be created, edited, approved, versioned, or disabled by an administrator. Configuration objects may be associated with a namespace, tenant, application, environment, or other administrative scope. Agents in that scope may refer to the configuration objects by name. This allows administrators to rotate credentials, change URLs, update connection pool settings, change LLM providers, adjust model limits, or revise standard prompts without modifying each agent specification.

In some embodiments, configuration objects improve security by separating sensitive values from agent specifications. For example, API authentication headers, database connection strings, LLM authentication headers, and other credentials may be stored in configuration objects rather than in agents. A first user who creates an agent may be permitted to reference a configuration object without being permitted to view one or more sensitive values stored in that configuration object.

In some embodiments, configuration objects also improve portability. The same agent specification may be executed in different environments by binding the named configuration objects to different environment-specific values. For example, a development environment may bind an API configuration name to a development API server, while a production environment may bind the same API configuration name to a production API server. Similarly, a database configuration name may resolve to different databases in different environments, and an LLM configuration name may resolve to different vendors, adapters, or models.

During execution, when an agent command refers to a named configuration object, the execution module retrieves the configuration object, validates that the agent is permitted to use the configuration object, merges permitted command-level values with configuration-level values, and executes the command using the resulting effective settings. Configuration-level values may be treated as defaults, restrictions, or non-overridable values depending on the type of value and the applicable administrative policy.

### Agent Descriptor

An agent descriptor describes an agent, so that it can be matched to a search query entered by a second user.

Like an agent specification, an agent descriptor is also specified in a machine-readable, textual format. This has the following advantages as mentioned for an agent specification.

An agent descriptor contains the following fields:
1. Agent name
2. Description
3. A list of filters
4. A list of classes in one or more classification schemes
5. A list of keywords
6. A list of names of named lists
7. A list of patterns
8. A list of named entities
9. A list of example queries

### Agent Name

Name of the agent that is described by this agent descriptor.

### DESCRIPTION

A first user uses this field to describe an agent in one or more paragraphs. Classifications, entities, keywords and example queries can be generated from this field using the first LLM service.

### Filters

A filter is a name and a list of possible values. Filters can be global to all agents, or they can be specific to agents in a namespace.

The system domain will define global filters related to second user location, second user device and search query attributes. Location related filters can be country, city and local time. Search query related filters can be the language the query is in, whether the query type is informational, transactional or navigational or whether the query is location based.

For filters defined by the system domain, the filter value need not be sent directly by the client module. It can be inferred from one of the inputs that the client module sends. For example, when a client module sends an IP address in the input, the execution module will map it to a location including country, city and local time and apply location-based filters. Similarly, the execution module would categorize the search query's language, type and whether it is location based using the search engine module and apply search query related filters.

First users can define filters that are specific to a namespace. For such filters, the client module would send the filter's name-value as an input, along with the search query. The execution module will select a subset of agents associated with that namespace based on filter values set in the agent descriptor for each agent.

### Classifications

The system domain can define multiple classification schemes like Cooperative Patent Classification and Library of Congress Classification. It can also define its own classification schemes, like a scheme called Current, that includes classes like News, Politics, Business, Health, Entertainment, Style, Travel, Sports, Science and Weather.

When a first user adds an agent descriptor to the index, the creation module will query the first LLM service to suggest classes in each classification scheme. The first user can select one or more of the suggested classes or add others.

A first user can add a classification scheme specific to a namespace and agents in the namespace can use that classification scheme. The first user would additionally specify an input prompt to the first LLM service or an API that can be called to find the class of a search query in the classification scheme.

### Keywords

Keywords are commonly used in full text search engines. Unlike filters and classification schemes, keywords are not defined by the system domain. First users can associate any keyword with an agent. Stop words defined by the system domain will be excluded from being included as a keyword.

Just like classifications, the creation module will suggest keywords to a first user based on the description, using the first LLM service.

### Named Lists

A named list is a list of strings with a name. A first user can create a named list from the first user GUI. These names can be of people, places, organizations, concepts etc. The named lists field in an agent descriptor can then refer to all the values in that list by just specifying the list name. The system domain can provide many such lists corresponding to popular people, places, company names etc. The system domain provided lists can be referred by any agent descriptor, whereas a first user created list can be referred only by an agent descriptor in their namespace.

To illustrate, a first user from namespace1 can upload a list of all National Football League team names and call it nfl.namespace1 and can refer to the entire list in the keywords as ‘nfl.namespace1’ from the named lists field.

### Patterns

A pattern is any word that cannot be found in a language dictionary. It can be made up of a combination of letters, numbers and punctuation. IP addresses, email addresses, International Standard Book Number, US postal service tracking number are all examples of patterns. Patterns are represented by regular expressions in an agent descriptor.

### Finding Patterns in a Search Query

It would be too expensive to match every word found in a search query against thousands of regular expressions defined by agents. A more practical approach is to drastically reduce the number of possible regular expression matches by storing certain meta data about each pattern defined by agents.

This invention uses the following method to find agents that match a pattern in the search query:
1. For each pattern in each agent, save the minimum and maximum number of letters, numbers and each punctuation character that is allowed in the pattern.
2. Find a word in the search query that is not part of the language dictionary.
3. Count the number of letters, numbers, and the number of each punctuation character in the word.
4. Find all the patterns that match the count of letters, numbers and punctuations that are within the numbers found in the word found.
5. The above steps will reduce the number of patterns to a small number.
6. For each pattern found in (4) match the regular expression for that pattern to the word found and check whether the word still matches.

The following table illustrates a few common patterns, and the metadata that would be associated with them.

| | Regular expression | Letters | Numbers | Hyphens | Dots | At @ |
|---|---|---|---|---|---|---|
| IP address | (\d{1,3}\.){3}\d{1,3} | 0 | 4 to 12 | 0 | 3 | 0 |
| Email address | \hat{ }\S+@\S+\.\S+$ | 3 to 192 | 0 to 190 | 0 to 190 | 1 | 1 |
| ISBN | \d+\-\d+\-\d+\-\d+,\d+ | 0 | 13 | 4 | 0 | 0 |
| Postal service | [A-Z]{2}\d{9}US | 4 | 9 | 0 | 0 | 0 |
| Flight number | [A-Z]{2}\d{1,4} | 2 | 1 to 4 | 0 | 0 | 0 |

### Named-Entities

This field specifies named entities found in the search query. A named entity consists of an entity type and an entity value.

For each entity type, this field specifies:
1. Minimum and maximum number of times the entity type can be present in a search query. If these fields are unspecified, then any number of this entity type can be present in the search query, including zero.
2. One or more classification of the entity value for which this agent is applicable. If classifications are not specified, then this entity would match all values for that entity.
   a. For example, an agent related to sports players records might look for person entities in the search query and only if the person found can be classified as a sports player by the search engine module.

Named entities can also specify one or more entity relationships between one entity and another. The search engine module can use the actual relationship found in a search query to find an agent that specify the same relationship between entities.

### Example Queries

Example queries are examples of possible search queries from a second user that should be matched to an agent. Like classifications and keywords, the creation module can generate a list of example queries based on the description field using the first LLM service. A first user can select one or more of the generated queries or add their own.

An example query can also be expressed in a generalized form by removing stopwords, replacing entities into entity types and question words into a placeholder. The motivation to do this is to make it easier to match search queries that ask a similar question about different entities. For example, an agent related to records of sports players can express an example query as “How many Wimbledons did Federer win?”. The generalized form of this example query would be “[QuestionWords] [event] [person] [action]?”, if ‘did’ is a stopword. Subsequently, when a second user issues a search query for “How many US Open did Nadal lose?”, it would get translated to “How many [event] [person] [action]” and would match the above agent.

When example queries are expressed in a generalized form, a search query also needs to be converted to its general form and matched against example queries. Prophetically, the search engine module might find a better match with generalized queries.

### Detailed Description of the Computing Platform

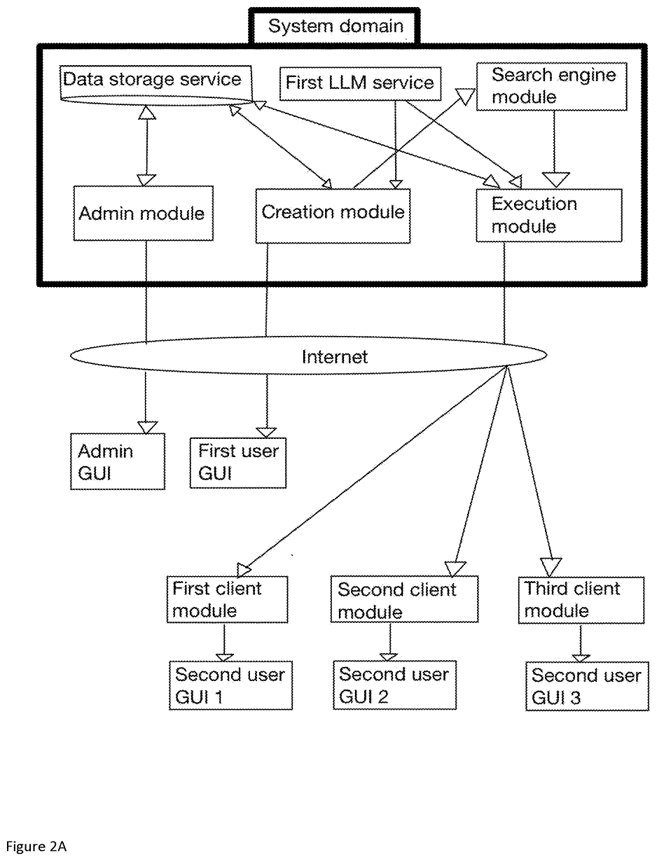

FIG. 2A shows the components of the computing platform of this invention. Some of the modules also have sections that specialize in certain areas of the module. The following table summarizes the components, their sections, if they have any, and their relationships. Each component is described in the paragraphs following the table.

| Component | Section | Used by |
|---|---|---|
| System domain | Indexer section | Authentication module |
| Data storage service | Search section | Admin module |
| First LLM service | Specification section | Creation module |
| Search engine module | Descriptor section | Execution module |
| Authentication module | Upload section | Creation module |
| Admin module | Searcher section | Execution module |
| Creation module | Fetch agent section | Creation module |
| Execution module | Function section | Execution module |
| Admin GUI | Event section | Admin GUI |
| First user GUI | Subscription section | First user GUI |
| Client module | | Admin GUI |
| Second user GUI | | First user GUI |
| | | First user GUI |
| | | First user GUI |
| | | Client module |
| | | Client module |
| | | Client module |
| | | Client module |
| | | Client module |
| | | Admin user |
| | | First user |
| | | Second user GUI |
| | | Second user |

### Data Storage Service

Data storage service provides a key-value storage service, an object storage service and a database service. This can be implemented by hosting such products or interfacing with cloud-based technologies mentioned in the prior art section.

### First LLM Service

The first LLM service is an interface to hosted LLMs in the system domain and LLMs available on the internet. Facebook Llama is an example of an LLM that can be hosted. ChatGPT and Anthropic are examples of LLMs that can be called over the internet.

The first LLM service will receive a model name, input and a list of parameters to the model. Parameters are model specific name-value pairs. Based on the model name, the first LLM service will select a hosted model in the system or send a call to a model's API on the internet. It will include the input and the parameters in a request to the model, receive an output from the model and return the output to the caller.

### Authentication Module

The system domain would include an authentication module to authenticate admin users and first users. Admin users and first users register and authenticate with the system domain using website registration and authentication mechanisms.

The authentication module would also provide integration to single sign-on systems of organizations, so that admin users and first users can register and login to the system domain using organization specific authentication mechanisms.

Implementing an authentication mechanism for a website or webservice, including integrating it with organizations' single sign-on systems are well known to a person of skill in the art.

### Admin Module and Admin GUI

Admin users use the admin module from the admin GUI. The admin module provides these functions for admin users:
1. Assume ownership of a unique namespace
2. Generate an authorization key for the namespace
3. Authorize first users to be associated with the namespace.
4. Set up an approval process for first users to create new agents or make changes to agent specifications and agent descriptors in the namespace. The system domain would provide an approval process that can be customized to each namespace that needs it.
5. Setup additional rules for validation of agent specifications and agent descriptors in the namespace
6. Setup a namespace to support subscriptions
7. Set up default values for parameters in search calls to the execution module
   a. An admin user can set up default values for search calls to the execution module and give it a name. A client module would send a customization name and receive customized search results based on the customized name. The kinds of customizations are mentioned in the searcher section in the execution module.

An admin user takes ownership of a namespace by requesting for it. The namespace cannot be owned by another admin user.

If a namespace matches or ends with an existing internet root domain name, the admin module may require verification of the ownership of the internet root domain by the admin user. Once an admin user takes ownership of a namespace, they may automatically own all the sublevels within that namespace. That is, if an admin user owns example.com, they will automatically own any namespace like first.example.com.

An authorization key for a namespace is a UUID generated by the admin module. The admin module stores the association between the authorization key and the namespace in the data storage service.

Once an admin user generates an authorization key for a namespace, they can approve a first user to be associated with that namespace. They can also assign the privileges of administering the namespace to the first user.

### Search Engine Module

Search engine module is internal to the system domain. It is used by the creation module to index agent descriptors and execution module to run a search.

The search engine module includes the following services:
1. Full text search service
2. Vector database service
3. Second LLM service
   a. Second LLM service is different from the first LLM service in the following ways:

| First LLM service | Second LLM service |
|---|---|
| Provides LLM services to agents | Provide LLM service to the search |
| running on client module | engine module |
| Represents many LLM models | A single LLM model |
| Read only models | This model can be fine-tuned |
| Can run in the system domain, | Runs in the system domain and is |
| internet or in an organization's | private to the system domain. |
| intranet. | |

4. Embeddings model service
   a. LLMs typically also provide an interface to an embeddings model service. This service can be implemented by interfacing with the embeddings model service of the second LLM service.
5. Relational database service

Each of the above services can be implemented using techniques mentioned in the prior art section. The search engine module will also include an NLP library, which can be called through its interface.

The search engine module includes an indexer section and a searcher section. The following paragraphs go through one way of matching a search query to one or more agents. A person of skill in the art will use different search algorithms established in the field of enterprise search to enhance and alter these methods.

### Indexer Section

Indexer section indexes an agent descriptor and maps it to an agent name in the search engine module.

The following table shows which fields are included in each part of the search engine:

| | Included | Vectorized and | Used for | Included |
|---|---|---|---|---|
| | in full | included in | fine-tuning | in |
| | text | Vector | in the | relational |
| | search | database | second LLM | database |
| | service | service | service | service |
| Namespace | Yes | No | No | Yes |
| Description | Yes | Yes | Yes | No |
| Filters | Yes | No | No | Yes |
| Classifications | Yes | No | No | No |
| Keywords | Yes | No | No | No |
| Named lists | Yes | No | No | Yes |
| Patterns | No | No | No | Yes |
| Entities | Yes | No | No | Yes |
| Example | No | Yes | Yes | No |
| queries | | | | |

For the fields included in the full text search engine, the following schema can be used:

| | | Remove | | | Single |
|---|---|---|---|---|---|
| | Tokenized | Stopwords | Lemmatized | Synonyms | valued |
| Namespace | no | No | no | No | yes |
| Description | yes | Yes | yes | Yes | yes |
| Filters | no | No | no | No | no |
| Classifi- | no | No | no | No | no |
| cations | | | | | |
| Keywords | no | No | yes | Yes | no |
| Named lists | yes | No | no | No | no |
| Entities | no | No | no | No | no |

Namespace is included in the search engine although it is not part of the agent descriptor. Agent title is also stored in the full text search engine service and relational database service, but not indexed. To facilitate searches In the full text search index, each namespace can be indexed to a different collection or shard. Alternately, namespace can just be a field in the full text search index and example queries can be filtered using that field. Vector databases support the concept of namespaces natively. In the relational database, namespace can be included in a column and results can be filtered based on that column.

Description and example queries fields will be vectorized using the embeddings model service and then included in the vector database service in a namespace that matches the agent's namespace.

Second LLM service can be fine-tuned with example queries as input and agent name as output. Second LLM service can also be fine-tuned with description as input and agent name as output.

Keywords will be indexed in the full text search service. They can also be included in the relational database.

Named lists can be indexed in two different ways. It can be included as a multivalued field in the full text search service after tokenization. This would help matching a search for “Cowboys next game” with an agent that supports searches on NFL teams. Named lists can also be indexed in the relational database by including namespace, agent name and each name in the named list in three columns and doing a regular SQL query on them.

Patterns metadata are included in the relation database to reduce the number of patterns to match for as explained in the section on patterns.

Filters and classifications are name-value pairs where one name can have multiple values. They can be stored in the search engine module with multivalued fields and in the relational database with multiple entries, one per each name-value combination.

Entities can also be stored both in the relational database and the full text search service.

### Searcher Section

Searcher section receives a namespace and a search request from the execution module and returns a list of agent names and titles. A search request contains a search query and a list of inputs, where each input is a name-value pair. The search request is processed with at least the following steps:
1. Filter the search to the subset of agents that match the namespace.
2. Determine values for system domain filters like location and search query attributes based on the search query and input values. Select agents that match filters in the inputs. Use the second LLM service in the search engine module to determine whether the search query is based on a location and filter agents that specify location-based filter to be true.
3. Classify the search query using either the NLP library or the second LLM service in the search engine, under each classification scheme. Select agents that match the classes specified for those classification schemes.
4. Find patterns in the search query by looking for words that are not in a language dictionary. Select agents that match those patterns, as explained in the patterns section.
5. Find all the named entities in the search query and their entity types and the entity relationships using the NLP library or the second LLM service in the search engine module. For each entity type found, find the classification of the entity value. Select agents that specify the entity types found in the search query and their classification. Give higher scores to agents that specify the same relationship between entities as found in the search query.
6. Select all the agents that specify words from the search query in the keywords field using the full text search service in the search engine module. Assign scores based on number of keywords matched.
7. Select all the agents that specify words from the search query as a value in named lists using the full text search in the search engine module. Assign scores based on matching the entire value in the named list.
8. Look up the vectorized search query in the vector database service in the search engine module and find nearest matched agents. Assign scores by normalized vector distances.
9. From the fine-tuned LLM model in the search engine module, input the search query and get agent names as output.
10. Assign weights to each of the methods above. Weights are floating point numbers between 0 and 1.
11. Assign a net relevancy score to each matched agent by multiplying the scores assigned in each method by the weight assigned in the previous step.
12. Order agents in decreasing net relevancy scores.
13. Select the top agents, based on how many matched agents were asked to be returned.
14. For selected agents
   a. Fetch titles from the full text search service or the database service
   b. Evaluate each title as a dynamic string
   c. Use second LLM service in the search engine module to convert evaluated titles to be grammatically correct
   d. Include selected agent names and titles from (c) above in a search results object.
15. Return the search results object.

The search request can also include several ways to customize the search logic described above and the information returned from the search call. Some of the customizations can be:
1. Specify the weights mentioned in step 10 to calculate net relevancy.
2. Specify the number of agent names to be returned.
3. Specify that agent specifications also be included for one or more matched agent names.

An admin user can setup search customizations for a namespace and the execution module can include them in search requests to the search engine module.

### Special Words in the Search Query

The client module can also process the search query to take specific actions.

For example, ‘@agent <first_agent_name> What events are happening around me?’ can execute an agent name first_agent_name with the search query “What events are happening around me?”.

### Creation Module

Creation module is used by first users from the first user GUI. It consists of the following sections:
1. Specification section
2. Descriptor section
3. Upload section

### Specification Section

Specification section creates and deletes agent specifications. First users create agents from the first user GUI by entering an agent specification. First user GUI will also provide a graphical interface to create an agent specification. The specification section validates the agent specification and if the validation succeeds, stores the agent specification in the data storage service, along with the namespace.

An admin user can define additional validation rules for agents in a namespace, over what the specification section performs by default. They can prevent usage of certain commands in the agent, like codeBlock. They can also specify rules on processing custom fields in the agent specification. The creation module would run additional validation specified for each namespace.

An admin user can set an approval process for a namespace that requires the admin user to approve new agent specifications and changes to existing agent specifications in the namespace. The process can also require approval to create or change agent descriptors. The approval process would be similar to app approval process on mobile platforms like Google Play Store and App Stores. A first user can also delete an agent specification and the corresponding agent descriptor.

### Descriptor Section

Descriptor section creates and deletes agent descriptors. An agent can be searched in the search engine module only if an agent descriptor is created for it. An agent can be created and tested before creating an agent descriptor.

This section validates an agent descriptor and if the validation succeeds sends it to the search engine module to index the descriptor.

As with specifications, an admin user can set up a namespace to require approvals, before a new agent descriptor is indexed or to make changes to existing agent descriptors.

When an agent descriptor is created, it sends a request to the indexer section of the search engine module to index the agent descriptor.

### Upload Section

Upload section processes upload of files to the system domain. First users can upload files to the system domain and then query them from an agent using the systemQuery command. The first user would specify an upload type for each file. Each upload type will be supported by a different cloud service. Such cloud services are explained in the prior art section. The upload section can implement this functionality by interfacing with the right cloud service for each type. Uploaded files would be associated with the namespace of the first user and can be queried only by client modules associated with that namespace. This can be implemented by saving the association between the uploaded file names and namespace in the data store service or by enforcing uploaded file names to have a suffix matching the namespace.

Some of the upload types are:
1. AI model files
2. A full text search engine
3. A vector database
4. A graph database
5. A relational database
6. A text file

For (2), (3), (4) and (5), the upload section would create a new, private search engine or database using the cloud service when a first file is uploaded. For (2), (3) and (4) JSON files can be used. For (5).db files can be used with SQLite or CSV files can be used with MySQL. More than one file can be uploaded to the same search engine or database. For each type, the underlying cloud service would determine what file formats are supported for that service.

The system domain itself can upload files of all the above types and make them available to all the namespaces.

Generating Agent Specification from a Natural Language Description

In some embodiments, the execution module may provide an interface for generating an agent specification from a natural language description. The interface may receive a description of a task, workflow, integration, or other behavior that an agent should perform.

The execution module may provide the natural language description to a large language model. The prompt provided to the large language model may include a description of the agent specification language, including the syntax and commands available for defining an agent. The prompt may also include information identifying APIs, databases, models, configuration objects, authentication mechanisms, and other resources available to agents in the system.

In some embodiments, the prompt may further include information about one or more existing agents in a namespace. For example, the prompt may include agent names, agent descriptions, supported inputs, expected outputs, tags, groups, versions, or other metadata associated with agents that are available in the namespace. The large language model may use this information to determine whether the generated agent should call an API or database directly, search for another agent, invoke another agent, or perform a combination of such operations.

The execution module may instruct the large language model to generate an agent specification that conforms to the agent specification language. The generated agent specification may include one or more tasks, command objects, action fields, variables, prompt commands, large language model commands, API commands, database commands, search commands, invoke commands, or other commands supported by the system.

In some embodiments, the generated agent specification may be returned to a developer for review before being stored or executed. In other embodiments, the generated agent specification may be validated automatically before being stored or executed. Validation may include checking syntax, checking whether referenced commands are supported, checking whether referenced APIs, databases, configuration objects, or agents exist, checking whether required parameters are present, checking whether variable names are valid, checking whether access restrictions are satisfied, or checking whether the generated agent specification complies with one or more system policies. The generated agent specification may also be validated by executing the generated agent specification with one or more sample queries and determining whether the generated agent completes successfully, produces an expected output, invokes expected commands, avoids runtime errors, and complies with applicable access restrictions or system policies.

After validation, the generated agent specification may be stored in an agent repository, associated with a namespace, assigned a version, indexed for search, or made available for execution by one or more client modules. In some embodiments, the generated agent specification may also be revised by providing the generated agent specification and a further natural language instruction to the large language model.

### First User GUI

First user GUI is used by first users and it interacts with the creation module. It provides a development environment to create agents and agent descriptors.

The first user GUI will provide at least the following functionalities:
1. Provide an interactive process to create an agent specification
2. Provide an interactive process to create an agent descriptor
   a. This will interface with the search engine module to suggest values for other fields in the agent descriptor based on the description field.
3. Check syntactic or functional errors in the agent specification
4. Provide an interface to upload files to the system domain
5. Provide an interface to upload named lists to the system domain
6. Execute an agent with each example query specified in the agent descriptor to show statistics on agent's runtime.
7. Show statistics on events generated by running agents.
8. Provide an interface to set up a proxy API call. This can be called from a system Function in an agent in the first user's namespace.

First user GUIs can run from within an organization and integrate with single sign-on systems in the organization, which would integrate with the authentication module in the system domain.

### Execution Module

Execution module is the point of contact for all the client modules and handles all their requests. It contains these sections:
1. Searcher section
2. Fetch agent section
3. Function section
4. Events section
5. Subscription section

### Searcher Section

Searcher section forwards search requests to the search engine module and responds with the results returned by the search engine module.

### Fetch Agent Section

Fetch agent section receives a request from a client module to fetch an agent specification, reads the agent specification from the data storage and returns it to the client module.

This section will check that the namespace of the agent requested is the same as the namespace of the client module making the request.

### Function Section

Function section handles requests from three commands:
1. systemLLM command
   a. This translates to a call to the first LLM service. These calls will be available from any namespace.
2. systemFunction command
   a. There are two kinds of system functions.
      i. Global functions are functions or APIs implemented in the system domain. These functions will be available from any namespace.
      ii. Namespace specific functions are API proxy calls to public APIs. A first user can set up an API proxy call in the system domain from the first user GUI. This API can be called from the system Function command by any agent in the first user's namespace. The purpose of using an API proxy in the system domain is to hide the authorization details from being exposed in the agent specification.
3. systemQuery command
   a. These calls would translate to corresponding calls to each cloud service supported in the system domain. The request will be processed only if the file being queried is associated with the namespace of the client module making the request.

### Events Section

Events section handles requests from the raiseEvent command. It receives an event name and a list of name-value parameters. It stores the agent name, event name, IP address of the client module that made the request, a timestamp and the name-value parameters to the data storage service. Additionally, it also logs them to a logging service.

Admin users and first users can set themselves up to be notified when an event occurs in their namespace or agent.

The system domain will define certain events that are common to all agents. For example, an event called exceptionRaised can specify that executing an event raised an exception in a client module. Another can be maximumRuntimeExceeded event, which can be raised when an agent runs beyond a maximum time set for that namespace.

Client modules can send an agentExecuted event every time they execute an agent, with time taken for the execution as a name-value parameter.

Client modules can also use events to track feedback from second users for an agent. A second user GUI can show a feedback GUI widget, which a second user can use to provide feedback on the agent. Client module can record the feedback as an event. A namespace administrator can adjust the relevancy score of agents based on feedback.

First user GUI will provide ways to summarize event data in a namespace similar to popular tools like Splunk.

### Subscription Section

A subscription section provides an interface to support subscriptions for a namespace.

An admin user can set up a namespace to support subscriptions in the admin module and set a subscription price and frequency. This namespace would then let first users mark an agent as a premium agent, which can be executed only when a second user buys a subscription to that namespace. They can also create a free version and a premium version of an agent.

The subscription section would accept subscription payments for a second user identifier using a payment gateway and would store the namespace and the second user identifier in the data storage service. A second user GUI would interact with this section to accept subscription payments seamlessly from a second user.

In each call to the execution module, client module would include a second user identifier as an input. The execution module would look up the second user identifier in the data storage and if there is an associated subscription, the request would be categorized as a premium request.

For a search agents request, the search engine module would:
1. Include a variable in the result called isPremiumUser and set it to true or false
2. If a request is premium, all agents would be searched.
3. If a request is not premium, two searches will be made-a first search for free agents and a second search for premium agents. Results from both the first search and second search would be included in separate lists in the search results. This allows a client module to execute a free agent but show the titles of premium agents that can offer better search results in the second user GUI.

For a request to retrieve an agent, if a request is not premium and the request is for a premium agent, the request will fail.

### Client Module

A client module:
1. Can be an independent application, be part of another application or can be built into a mobile app
2. Runs anywhere on the internet or within the system domain
3. Communicates with the execution module in the system domain
4. Has access to an authorization key for a namespace
5. Includes the authorization key in each request it sends to the execution module. The execution module associates a namespace with the request based on the authorization key
6. Exposes a REST interface which can be consumed by a second user GUI

Many client modules would run on the internet, each representing a namespace. Multiple client modules can represent the same namespace.

The client module typically receives search requests from a second user through the second user GUI. It can also receive a request from any REST client. A search request consists of:
1. A search query
2. One or more inputs, which are name-value pairs
3. An optional ConvID

In some embodiments, the client module may process a search request by performing one or more of the following example actions. These actions are illustrative and non-exhaustive, and other actions or workflows may be used for other search requests or use cases:
1. Send a request to the execution module to search for agents with the authorization key, search query and inputs
2. Receive an agent name and agent specification, where the agent specification may be in the original form as entered by a first user or in another form.
3. Create an agent instance from the agent specification
4. If there is no ConvID in the request, create a ConvID and a new conversation state object. If there is a ConvID in the request, restore a conversation state object from the data storage service corresponding to the ConvID.
5. Add the search query and input name-value pairs to the conversation state object.
6. Execute a task unit called main in the list of task units in the agent. To execute a task unit:
   a. Execute each command unit in the order they are specified in the task unit.
   b. Each command unit is executed as explained in the section describing that command unit in this document.
   c. If a command calls another task unit, execute that task unit.
   d. Execution ends when there are no more commands to execute in the previous step.
   e. Outputs from the output action field are streamed to the second user GUI.
7. Executing an agent can result in:
   a. Agent completing successfully
      i. Store the conversation state object in the data storage service.
      ii. Send an agentExecuted event to the execution module
   b. Agent throws an exception
      i. Send an error response
      ii. Send an agentFailed event to the execution module
   c. Agent runs for too long
      i. Send an error response
      ii. Send an agentFailed event to the execution module, with long duration as the cause
      iii. Agent stops execution at the end of a command or command unit.

In processing a search query, a client module can choose not to execute an agent automatically. It can instead show a list of agent titles on the second user GUI and let a second user choose one or more agents to run.

### Second User GUI

Second user GUI is specific to a client module. It is used by second users. At a minimum, the second user GUI takes a search query from a second user and shows the result from executing an agent.

Second user GUI can be customized to:
1. Show a list of evaluated titles of matched agents to a search query and let a second user pick an agent to execute.
2. Execute multiple agents and show results from each one on the GUI

A second user GUI can be a web page, an independent application or part of a mobile app.

Every agent in a namespace can be accessed with a URL relative to a client module. A second user can bookmark an agent from the second user GUI and execute a specific agent. They can also call an agent's URL from a script or a program.

Multiple Client Modules with the Same Authorization Key

An organization can run several client modules, each customized to a different environment, like Java or Python, or customized with different language packages, or running in different areas of a corporate intranet with access to different systems and private APIs.

With this setup, a central client module can run search queries and from the search results, forward an agent name to the right client module for execution. A second user GUI connected to the central client module will be able to engage all the agents in that namespace, although each agent requires a different environment to execute.

### Publishing an Authorization Key for a Namespace

An admin user can publish the authorization key of a namespace publicly. This allows anyone to run a client module with that authorization key.

With this setup, agents can be created which access to a system or function available only from a second user's machine. This can be a useful technique to run customer support agents or software tools.

For example, an agent can respond to search queries like “Are there single point of failures in my Solr cloud running at http://localhost:1100”. This agent would make a systemLLM call to generate the code that can query a Solr cloud, pass the generated code to a codeBlock command and execute the code to produce an answer. The URL http://localhost:1100 is accessible only from a second user's machine.

### Agent Specification and Descriptor Versioning

In some embodiments, the data storage service maintains prior versions of agent specifications and agent descriptors. When an agent specification or agent descriptor is created, edited, validated, published, unpublished, or otherwise modified, the data storage service can store a new version of the agent specification or agent descriptor.

Each stored version can include the corresponding content, a version identifier, a timestamp, and an identifier of the first user that caused the version to be created.

The data storage service can provide version control functions for agent specifications and agent descriptors, including viewing prior versions, comparing two versions, identifying differences between versions, displaying version history, and creating a new draft from a prior version.

A comparison between versions can identify changes to fields, command units, task units, configuration references, prompts, variables, descriptors, metadata, publication status, indexing status, or other portions of an agent specification or agent descriptor.

### Security and Execution Controls

In some embodiments, the system validates and executes agent specifications in a manner that reduces the risk that an agent will intentionally or unintentionally execute harmful code. Harmful code can include code that accesses resources outside the agent, consumes excessive processor or memory resources, escapes the execution environment, accesses unauthorized variables or objects, or otherwise performs operations not permitted for the agent. Although agent code and expressions can be implemented using many programming languages, this section uses Python as an illustrative native language.

Harmful code can be detected and controlled at two levels. First, harmful code can be detected when the agent specification is parsed, compiled, or otherwise validated before execution. Second, harmful code can be detected or limited while the agent is running.

Before an agent is executed, the agent specification must pass validation. Validation can include determining whether the agent specification has the required syntax, whether the agent specification conforms to the command structure expected by the system, whether the agent specification is within a maximum permitted size, and whether expressions contained in the agent specification use only permitted language constructs. For example, the system can impose a maximum size on an agent specification, such as a maximum size measured in kilobytes. If the agent specification exceeds the maximum size, the system can reject the agent, prevent publication of the agent, or prevent execution of the agent.

In some embodiments, validation includes enforcing one or more agent validation limits. The validation limits can include a maximum agent runtime, a maximum number of loop iterations, a maximum API response size, a maximum number of rows returned or processed by a database call, a maximum agent specification size, or other execution or resource limits. The maximum runtime can limit how long an agent is permitted to execute. The maximum loop iteration count can limit iterations of while commands, for commands, forEach commands, list comprehensions, dictionary comprehensions, generator expressions, or other iterative constructs. The maximum API response size can cause an API call to fail when the response exceeds a permitted size. The maximum database row limit can limit how many rows are returned by, read from, or processed from a database call.

For example, dynamic strings used by the agent specification can contain expressions written in a native language, such as Python. Those expressions are parsed before execution to identify language constructs that can access variables, objects, methods, resources, or execution facilities outside the permitted agent environment. In some embodiments, the validation process rejects or removes potentially harmful language constructs from expressions contained in dynamic strings. For example, Python constructs that access dunder methods or dunder attributes can be rejected because they can permit access to implementation details or objects outside the intended execution environment. Attribute access, function calls, imports, indexing operations, comprehensions, generator expressions, or other expression structures can also be inspected during parsing and allowed, rejected, rewritten, or limited according to security rules.

In some embodiments, the parser generates or processes an abstract syntax tree for each expression contained in a dynamic string. The abstract syntax tree is checked against a set of permitted node types and permitted operations. Nodes or operations that are not permitted are rejected or transformed before the agent can be executed. The parser can also enforce compile-time limits on expression structure, including a maximum comprehension depth, a maximum number of generators in a comprehension, or other structural limits on expressions.

In some embodiments, one or more native-language operators are handled according to an operator mapping. The operator mapping can specify, for each operator or class of operators, whether the operator is allowed, denied, or rewritten. For example, arithmetic operators, bit-shift operators, matrix multiplication operators, exponentiation operators, string operators, collection operators, or other operators can each be allowed, denied, or rewritten. An allowed operator can remain in the expression. A denied operator can cause validation to fail. A rewritten operator can be transformed at parse time into a call to a system-provided safe function. Different operators can have different default mappings. For example, some ordinary arithmetic operators can be allowed, operators that are more likely to produce excessive memory or processor usage can be rewritten, and operators that are not needed for agent execution can be denied.

During execution, the system can enforce runtime controls in addition to parse-time validation. Safe functions that implement rewritten operators can check upper bounds before performing an operation. For example, a safe string concatenation function can check a maximum output length, a safe multiplication function can check numeric magnitude or iteration count, a safe exponentiation function can check operand size, and a safe collection operation can check a maximum collection size. If a requested operation exceeds a permitted bound, the safe function can return an error, terminate the agent, or otherwise prevent the operation from completing.

Loop constructs in the agent specification can also be limited. In some embodiments, each loop has an explicit or implicit maximum number of iterations. The maximum can apply to while commands, for commands, forEach commands, list comprehensions, dictionary comprehensions, generator expressions, or other iterative constructs. The maximum can be specified by the agent specification, by a namespace configuration, by a system configuration, or by the execution module. If the loop exceeds the maximum number of iterations, the execution module can terminate the loop, terminate the current task, or terminate the agent with an error. Similar limits can be applied to recursion, nested loops, repeated agent invocations, repeated search operations, repeated API calls, repeated database calls, or other repeated execution structures.

In some embodiments, the system also controls whether an agent can define custom external resources. For example, a compile option or validation option can specify whether custom APIs can be defined in agents, whether custom databases can be defined in agents, or whether the agent must use only APIs and databases previously configured for a namespace or execution environment. If custom APIs or custom databases are not permitted, the parser or validation process can reject agent specifications that attempt to define them.

In some embodiments, validation is performed when an agent is created, when an agent is updated, when an agent is approved for use, when an agent is loaded for execution, or immediately before the agent is executed. Validation results can be stored with the agent specification so that an agent that has not changed need not be fully revalidated on every execution. If the agent specification, system configuration, allowlist, parser, security rule set, compile option, validation option, or runtime version changes, the agent can be revalidated before further execution.

If validation fails, the system can prevent the agent from being stored, prevent the agent from being published, prevent the agent from being executed, mark the agent as invalid, or return an error to the user or developer. If a runtime security limit is exceeded during execution, the execution module can stop the offending operation, stop the current command, stop the current task, stop the agent, log the event, emit trace information, or return a failure result. In this manner, the system can reduce the risk that an agent specification will execute harmful code, while still allowing controlled use of native-language expressions within the agent specification.

### Usage Reports and Analytics

The system may generate usage reports and analytics based on execution data collected while agents, commands, tools, models, and application server components are used. The reports may be generated for a developer, administrator, customer, tenant, workspace, application, project, agent, model, end user, time period, or other reporting scope.

In some embodiments, the system records an execution event when an agent is executed. The execution event may include an agent identifier, an agent name, an agent version, a start time, an end time, an execution duration, an execution status, an invoking user or account, an application identifier, a tenant identifier, and one or more error codes or error messages. The recorded execution events may be aggregated to generate an agent execution report.

An agent execution report may be generated for a selected time window having a start time and an end time. The agent execution report may include, for each agent, an agent name, a number of successful executions, a number of users that executed the agent, a minimum execution duration, a maximum execution duration, an average execution duration, and a percentile execution duration. For example, the percentile execution duration may be a ninety-fifth percentile execution duration. The report may also include total executions, failed executions, last execution time, and execution counts over selected time intervals. The report may identify agents that are frequently used, agents that are rarely used, and agents having increasing or decreasing usage over time.

The system may also generate an agent failure report. The agent failure report may be generated for a selected time window having a start time and an end time. The agent failure report may identify runtime failures encountered during execution of one or more agents. The report may group failures by agent, agent version, agent error code, command, tool, error type, error message, exception, status code, user, tenant, or time period.

In some embodiments, an agent failure report may include, for an agent, one or more agent versions and, for each agent version, one or more failure groups. Each failure group may be associated with an agent error code and may include a count of failures, a number of users affected by the failures, and one or more failure records. Each failure record may include a user query, an error message, and a time at which the failure occurred. In some embodiments, the report may distinguish between failures caused by invalid agent specifications, missing configuration values, authentication errors, authorization errors, external API errors, tool execution errors, large language model errors, timeout errors, rate-limit errors, and system errors.

The system may also generate an agent failures summary report. The agent failures summary report may be generated for a selected time window having a start time and an end time. The agent failures summary report may include, for each agent, an agent name, a count of affected users, and failure counts grouped by agent error code. The summary report may be used to identify agents having frequent failures, recurring error codes, or failures affecting multiple users.

The system may generate a large language model usage report. The large language model usage report may be generated for a selected time window having a start time and an end time. The large language model usage report may provide visibility into usage of one or more large language models during agent execution. The report may group usage by large language model vendor and large language model. For each vendor and model, the report may include a number of input text tokens, a number of output text tokens, a number of input image tokens, and a number of output image tokens.

In some embodiments, the large language model usage report may include an agent-level token breakdown. The agent-level token breakdown may identify, for each agent that used a particular large language model, an agent name, input text token usage, output text token usage, input image token usage, and output image token usage. The report may also include the number of model requests, latency, errors, and an estimated cost. The estimated cost may be calculated using per-token pricing, per-request pricing, image-token pricing, or other pricing parameters configured in model settings. The report may aggregate usage by model, vendor, agent, user, tenant, application, project, prompt, time period, or other reporting dimension.

In some embodiments, the large language model usage report may include a report method field, mode field, or other indicator identifying how the report was generated, filtered, calculated, or requested. For example, the field may indicate whether a particular reporting method, calculation mode, or aggregation mode was used.

The system may also generate user usage reports. A user usage report may aggregate execution and model-usage data by end user, customer user, developer, administrator, account, tenant, workspace, or other user-related identifier. The report may indicate which users executed agents most frequently, which users invoked the client module most frequently, which users consumed the most LLM tokens, and which users incurred the highest estimated LLM cost.

In some embodiments, the user usage report may include, for each user, a number of agent executions, a number of client module requests, a number of LLM requests, input text token usage, output text token usage, input image token usage, output image token usage, total token usage, estimated cost, average cost per execution, average latency, number of failed executions, and last activity time. The report may be filtered or grouped by time period, agent, agent version, model, application, tenant, workspace, project, or other reporting dimension.

The estimated cost for a user may be calculated by associating LLM usage events with the user or account that caused the corresponding agent execution or client module request. The system may then apply pricing information from model settings to the recorded token usage or request usage. In some embodiments, the report may be used to identify heavy users, allocate costs among customers or departments, enforce usage limits, detect abnormal usage, or support billing, auditing, capacity planning, and product analytics.

In some embodiments, LLM usage analytics may be used to identify high-cost agents, high-cost prompts, unusually large prompts, unusually large responses, unusually large image inputs, unusually large image outputs, repeated model failures, rate-limit conditions, or inefficient model usage. The system may present such information to a developer or administrator to support debugging, optimization, model selection, cost control, and capacity planning.

The system may generate an application server status report. The application server status report may indicate the operational status of one or more application server components. The report may include server uptime, request volume, request latency, error rate, queue depth, active sessions, memory usage, CPU usage, database connectivity, cache connectivity, external service connectivity, worker status, task backlog, and recent system errors. In some embodiments, the report may identify degraded components, unavailable components, failed background jobs, or configuration errors.

The reports may be displayed in a user interface, exported as files, transmitted through an API, stored in a database, or provided to an external monitoring or analytics system. The reports may be generated on demand, periodically, or in response to a detected condition. Access to the reports may be restricted based on user role, tenant, organization, project, group, or other access-control information.

In some embodiments, report data may be filtered, sorted, searched, grouped, or aggregated. For example, a user may filter an LLM usage report by model and date range, group an agent execution report by agent version, group an agent failure report by agent error code, sort an agent failure report by failure count, or sort an agent execution report by ninety-fifth percentile execution duration. The system may also provide charts, tables, summaries, alerts, or recommendations based on the collected analytics.

The usage reports and analytics may be generated without changing the agent specification being executed. For example, execution metadata may be collected by the runtime system as agents execute. As a result, the same agent specification may be used both to perform the requested task and to generate operational analytics about how the agent was used.

### Orchestrator Agents

In some embodiments, the search engine module can be configured to always send each query to an agent marked as an orchestrator agent for a particular namespace.

An orchestrator agent is written like any other agent. Typically, an orchestrator agent uses a search command to search for other agents and an invoke command to call the other agents.

In one example, an orchestrator agent sends the user query to a large language model using a systemLLM command. The large language model is instructed to split the query into parts. For each part, the orchestrator agent searches for an agent using the search command and calls that agent using the invoke command. Each sub-agent may provide information or take an action. After calling the agents for the parts, the orchestrator agent uses a systemLLM command to summarize the actions and provide an answer.

### Secrets

In some embodiments, the system uses a secrets configuration to control where secret values are read from and how secret names are transformed before lookup. A secret can include an API key, token, password, database credential, private endpoint credential, or other value that should not be written directly in an agent specification.

The secrets configuration can include a readFrom field. The readFrom field identifies a source from which secret values are read. The source can include environment variables, one or more files, a cloud secrets service associated with the system domain, or another secure storage location.

When an agent specification, command, configuration profile, or other system component references a secret by name, the system uses the readFrom field to determine where the corresponding secret value should be retrieved.

The secrets configuration can also include a transform field. The transform field groups one or more rules used to rewrite a secret name before the system attempts to locate the secret value. The transform field allows the same agent specification or configuration profile to reference a logical secret name while allowing the deployed system to use a different naming convention for the stored secret.

A transform rule can include a match field. The match field defines a text pattern to be searched for in the secret name. The pattern can identify a prefix, suffix, substring, regular expression, or other matching expression supported by the implementation.

A transform rule can include a replace field. The replace field defines replacement text that is substituted for text matching the match field. For example, a transform rule can replace a logical prefix used in an agent specification with a deployment-specific prefix used in environment variables, files, or cloud secret names.

A transform rule can include a convertTo field. The convertTo field defines whether the transformed secret name is converted to upper case, converted to lower case, or left unchanged before lookup. This permits the system to support secret stores that require or conventionally use a particular case format.

In some embodiments, when a secret is requested, the system first receives or identifies the secret name, applies any transform rule to the secret name, applies any case conversion specified by the convertTo field, and then searches for the resulting transformed secret name in the source identified by the readFrom field. If the transformed secret name is found, the corresponding secret value is returned to the component that requested the secret. If the transformed secret name is not found, the system can return an error, deny execution of the command that requested the secret, or apply another configured failure behavior.

The secret value itself is not stored in the agent specification. Instead, the agent specification can reference the secret by name. This allows the same agent specification to be used across different deployments without embedding sensitive values in the agent specification and without changing the agent specification when the underlying secret value is rotated.

The following agent specification illustrates an orchestrator agent:

{
″agentVars″: {
″input_queries″: [ ],
″processing_query″: 0
},
″taskUnits″: {
″getQueries″: {
″commands″: [
{
″command″: {
″name″: ″prompt″,
″promptName″: ″splitterPrompt″,
″system″: ″You are an expert in corporate systems and understand the corporate users and
their IT requirements. I have many corporate systems. Split the request into multiple steps, where
each step would typically be served by a single corporate system. Just give me each step as a
question on a single line. Do not include anything else in the answer as I will parse this directly.″,
″user″: ″{query}″
}
},
{
″progress″: ″Splitting query into individual steps″,
″command″: {
″name″: ″systemLLM″,
″promptName″: ″splitterPrompt″,
″profile″: ″gemini″
},
″query_steps″: ″{ result.get_text( ).splitlines( ) }″,
″progress1″: ″{ f′Query steps: {query_steps}′ }″,
″input_queries″: ″{ [q, ′not_started′] for q in query_steps] }″,
″processing_query″: 0
}
]
},
″iterateQueries″: {
″commands″: [
{
″command″: {
″name″: ″for″,
″iter″: ″{ enumerate(query_steps[processing_query:]) }″,
″loopVar″: [
″query_index″,
″aquery″
],
″do″: [
{
″command″: {
″name″: ″search″,
″query″: ″{ aquery }″,
″tags″: ″corporate″
},
″progress″: ″{ f\″Matched query ′{aquery}′ with agent {result[0]}\″ }″
},
{
″progress″: ″{ f\″Running agent {result[0].get(′agentTitle′)} for query ′{aquery}′\″ }″,
″command″: {
″name″: ″invoke″,
″agentName″: ″{ result[0].get(′agentName′) }″,
″inputs″: {
″query″: ″{ aquery }″,
″userInputs″: ″{ userInputs }″
},
″agentVersion″: ″{ result[0].get(′agentVersion′) }″
},
″processing_query″: ″{ query_index + 1 }″,
″userInputs″: { }
},
{
″input_queries″: [ ],
″processing_query″: 0
}
]
}
}
]
},
″summarize″: {
″commands″: [
{
″command″: {
″name″: ″prompt″,
″system″: ″You are an expert in corporate systems and understand the corporate users and
their IT requirements. I have collected information from multiple systems. Use all that and answer
the question.″,
″user″: ″{ query }″
}
},
{
″progress″: ″Ran all the agents..summarizing the result″,
″command″: {
″name″: ″systemLLM″,
″profile″: ″openai″
},
″output″: ″{ result }″
}
]
},
″main″: {
″commands″: [ ]
}
}
}

### Agent Validation and Publishing

Agent validation is the process of executing an agent in a development mode by a first user before the agent is made available for use by second users. In the development mode, the agent can be executed using one or more input queries, test queries, sample inputs, or validation inputs provided by the first user. To pass validation, the agent should execute in the validation mode to completion without errors for the one or more input queries. The validation process allows the first user to confirm that the agent specification is syntactically valid, that the agent executes as intended, and that the agent produces expected outputs before the agent is published.

During validation, the creation module, execution module, or another validation component may check the agent specification for syntax errors, missing required fields, invalid command parameters, invalid references to variables, invalid references to configured APIs, databases, prompts, or large language models, and other structural errors. The validation process may also check the agent specification for insecure constructs as described in the security section. For example, the validation process may reject, flag, or rewrite commands, expressions, or operators that are not permitted by the applicable security policy.

The validation process may also execute the agent in a tracing mode. In the tracing mode, the execution module records trace information as the agent executes one or more commands. The trace information may include an identification of each command being executed, a status of each command, one or more input values, one or more output values, one or more variable values, timing information, error information, or other execution information. The trace information may be displayed to the first user during execution or after execution. The trace information allows the first user to inspect how the agent processed a query and to identify errors in the agent specification.

A first user may add additional trace information by including one or more trace action fields in the agent specification. When a trace action field is reached during execution, the execution module emits trace information specified by the trace action field. For example, the trace action field may cause the execution module to display a selected variable value, an intermediate result, a command result, or another item of diagnostic information. The trace action field allows the first user to provide targeted diagnostic output without changing the functional behavior of the agent for end users.

Before publication, an unvalidated agent may be stored in a private area of the data storage service. The private area may be referred to as drafts. Drafts are visible to one or more authorized first users but are not visible to second users and are not returned as executable agents in response to second-user searches. A draft may include an agent specification, an agent descriptor, version information, validation status, and other metadata. The draft allows a first user to save work in progress without making the agent available to second users.

Publishing is the process of storing an agent in the data storage service and making the agent available for use by second users. Only an agent that has passed validation can be published. In response to a publishing action, the system stores the validated agent specification, version information, metadata, access control information, and an associated agent descriptor in the data storage service. The published agent may then be available for execution by second users, subject to namespace, group, tag, authorization, and other access controls.

Before an agent descriptor can be indexed by the search engine module, the corresponding agent should be published. In some embodiments, the search engine module indexes only descriptors associated with published agents. As a result, an unpublished agent may be validated and tested by first users in the development mode, but may be excluded from search results returned to second users. This prevents draft agents, development versions, incomplete agents, unvalidated agents, and agents that have not passed validation from being discovered or executed by second users.

The validation and publishing process may be used both when a new agent is created and when an existing agent is edited. When an existing published agent is edited, the edited version may be stored as a draft until it passes validation. After the edited version passes validation, the edited version may be published as a new version of the agent. Until the edited version is published, second users may continue to access the previously published version.

When multiple first users attempt to edit and publish the same agent, the system may use version information to prevent conflicting publications. For example, when a first user begins editing an agent, the draft may be associated with the version of the agent from which the draft was created. If another first user publishes a newer version of the same agent before the draft is published, the execution module, creation module, or publishing component may block publication of the older draft. The first user associated with the older draft may be required to fetch the latest published version, merge the latest published version with the draft, revalidate the merged version, and publish the merged version only after validation succeeds. This prevents an older draft from overwriting a newer published version of the same agent.

### DETAILED DESCRIPTION OF DRAWINGS

FIG. 1A describes an agent using a class in an object oriented design in a UML class diagram. An agent specification described earlier can be converted from JSON to the Agent class shown in this figure using standard JSON to object libraries like Google Gson. The arrows indicate one-to-one and one-to-many relationships. Each command in an agent specification described earlier is shown as a value in the CommandType enumeration.

FIG. 1B shows each command in the agent specification as a derived class of CommandSpec in an object oriented design in a UML class diagram.

FIG. 2A illustrates the components of the invention. The boundaries of the system domain are marked with a thick outline. The four bottom row modules, Authentication module, Admin module, creation module and execution modules, do not communicate directly with each other and they can be accessed from the internet. Data storage service, first LLM service and the search engine module cannot be accessed outside of system domain. First LLM service is read-only. Data storage service is read and written from all the four bottom row modules. Creation module indexes into the search engine module and execution module searches from it. The direction of arrows represent the flow of data between modules.

Three client modules are shown each with a second user GUI. Each client module and second user GUI may have customizations specific to their own namespaces.

The lines and arrows flowing out of the system domain indicate a majority communication flow between modules and GUIs. Client modules communicate only with the execution module and this is shown by lines diverging from the execution module, through the internet. Admin GUI communicates with the admin module and first user GUI communicates with the creation module.

Authentication module is used by both admin GUI and creation GUI, but this is not shown in the picture, as it just implements standard website functionality.

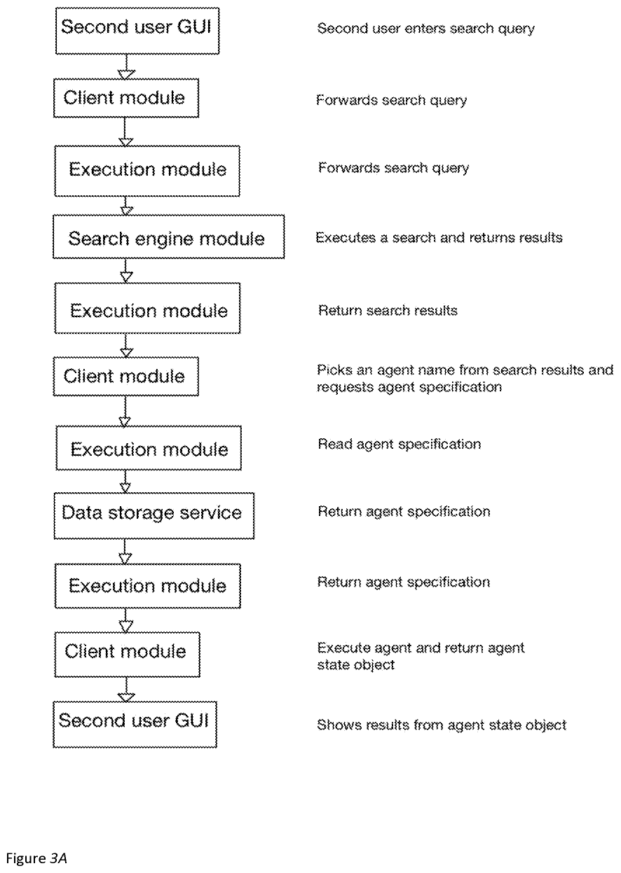

FIG. 3A illustrates the flow of information and actions that take place when a second user enters a search query. The modules and GUIs are shown on the left column and the action that takes place inside the module or GUI is shown on the right column.

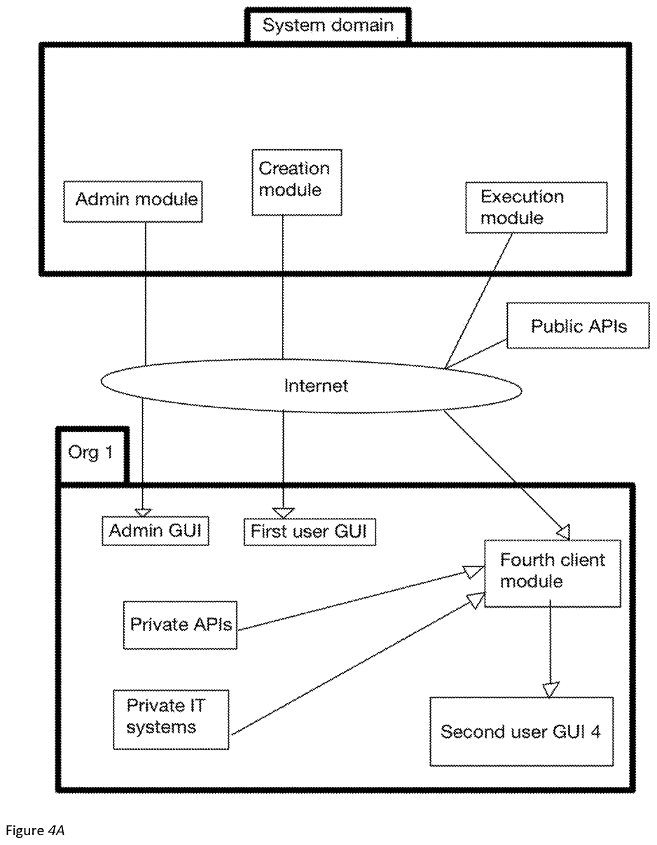

FIG. 4A illustrates a first embodiment of the invention where a first organization owns a first namespace and provides enterprise solutions within its corporate intranet called org 1. The boundaries of org 1 are shown with a thick outline. For clarity, only the three modules of the system domain are shown, as these are the ones that communicate with org 1.

Admin GUI and first user GUI are shown inside org 1 to indicate that they use a corporate single sign-on mechanism to login to the system domain and to indicate that admin users and first users would be first organization personnel.

A fourth client module runs inside org 1 and connects with the execution module. Agents in the first namespace run in the fourth client module. They can access private APIs and corporate Information Technology (IT) systems that are available only within org 1. They can also access public APIs on the internet. A second user GUI 4 shown connected to the fourth client module is available only from within org 1, as second users would also be first organization personnel.

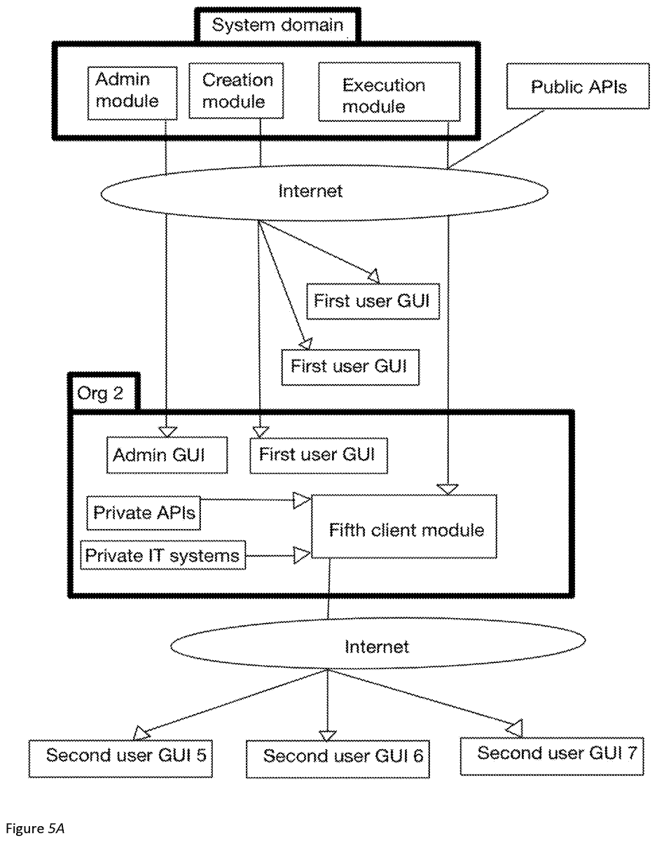

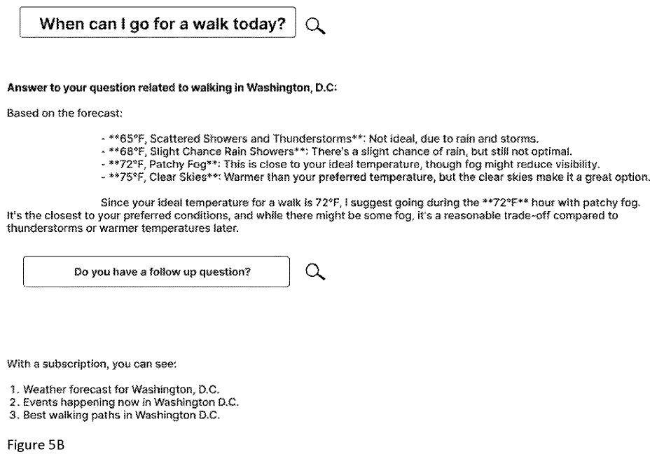

FIGS. 5A and 5B Illustrate a second embodiment of the invention where a second organization owns a second namespace and provides internet search and E-commerce services. The second organization controls an intranet called org 2 and runs a fifth client module inside org 2. It offers a free service which executes a subset of agents in the second namespace and a subscription-based service, which executes any agent in the second namespace.

Second organization personnel can become first users in the second namespace, as shown by first user GUI inside org 2. Second organization also authorizes non-personnel on the internet to be first users in the second namespace. This is indicated by two first user GUI boxes outside org 2.

Personnel from the second organization will approve all the agent specifications and agent descriptors that are created in the second namespace. This is indicated by an admin GUI inside org 2.

All the agents are executed in the fifth client module, which runs inside org 2. This allows the second organization to make private APIs and private IT systems available to agents in the second namespace.

Three second user GUI 5s are shown to indicate that anyone on the internet can run search queries in the second namespace. Second user GUI 5 can be an internet browser like Google Chrome, second user GUI 6 can be a GUI inside a mobile app and second user GUI 7 can be inside an app in a wearable device.

FIG. 5B illustrates second user GUI 5 when a search query is executed. A second user entered the query ‘When can I go for a walk today?’ and got an answer. There are three premium agents shown below the answer that are available only with a subscription. A textbox is also shown for a follow up question. The mechanics of an agent that can provide this answer is illustrated in the ‘illustration of an agent’ section.

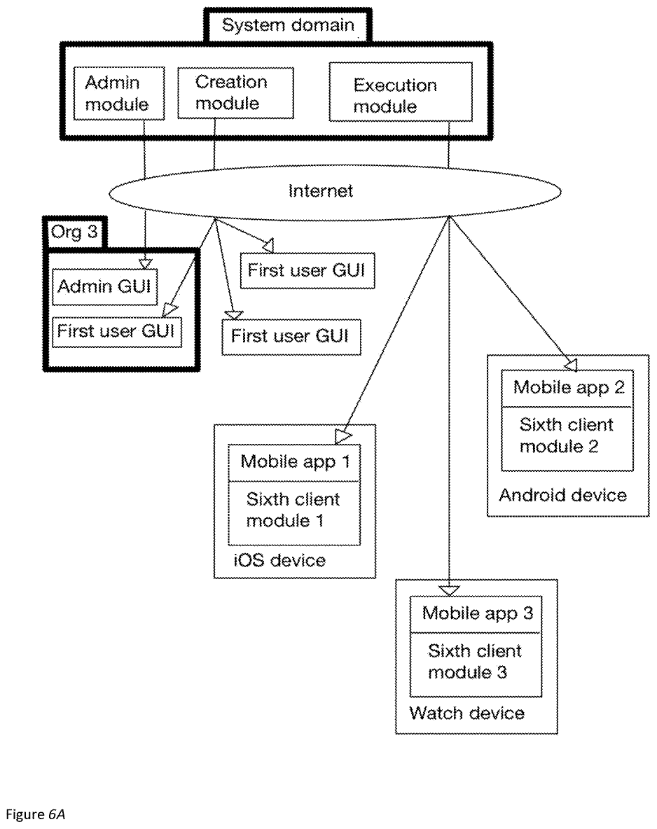

FIG. 6A Illustrates a third embodiment of the invention in which a third organization owns namespace 3 and provides mobile app services. The third organization controls an intranet called org 3. The third organization sells an app that is packaged with a sixth client module.

The mobile app has three versions, mobile app 1, mobile app 2 and mobile app 3 for App Store, Play store and a watch platform. All three versions of the sixth client module include the same authorization key, which is associated with the third namespace. All three versions of the mobile app support search queries entered both textually in the app and verbally to the mobile device.

Just like the second organization, the third organization allows both third organization personnel and others to be first users, but third organization personnel approve all the agent specifications and descriptors.

Each sixth client module converts an agent specification into an agent instance in that native platform. Sixth client module 1 will convert an agent specification into an agent instance on iOS, sixth client module 2 into an agent instance on Android and sixth module 3 into an agent instance on the watch platform. This allows a single agent specification to execute on all the three platforms.

### Illustration of Agent Specifications

The following sections illustrate several agent specifications. Each agent specification is written in JSONC format, which is JSON format with embedded comments.

First agent specification is a weather agent that answers user's questions based on the local weather. It uses a RAG agent workflow.

{
″agentVars″: {
″hasInit″: false // Variable scoped at the agent level
},
″functions″: {
″init″: { // init function is called only when this agent executes for the first time in a conversation
″commands″: [
{
″command″: {
″name″: ″api″, // Calls api command
″url″: ″https://api.ip2location.io″, // A paid service online to fetch a location from an IP
address
″params″: {
″ip″: ″{ip}″, // Second user′s IP address
″key″: ″{secret(′IP2LOCATION_KEY′)}″ // Fetches a secret called IP2LOCATION_KEY as
explained in the Secrets section
}
},
″location″: ″{ result }″, // A task unit level variable called location is set
″progress″: ″{ f′Got your location: {location[′city_name′]}, {location[′region_name′]}′ }″ // This
is shown to the second user in the second user GUI
},
{
″command″: {
″name″: ″if″,
″condition″: ″{ location[′country_code′] != ′US′ }″, // Accesses the location variable set in the
previous command unit
″then″: [
{
″fail″: ″{ f′You are in {location[′city_name′]}, {location[′country_name′]}. This agent
supports only locations in the USA′ }″ // Ends the agent with a failure, if the second user is not from
the US
}
]
}
},
{
″command″: {
″name″: ″api″,
″url″: ″{ f′https://api.weather.gov/points/{location[′latitude′]},{location[′longitude′]}′ }″ //
Calls US govt. weather service
}
},
{
″command″: {
″name″: ″api″,
″url″: ″{ result[′properties′][′forecastHourly′] }″
},
″weatherData″: ″{ [f′In {period[′number′]} hours: {period[′temperature′]} and
{period[′shortForecast′]}. ′ for period in result[′properties′][′periods′][:8] }″,
″progress″: ″Found the weather in your location for the next 8 hours″
},
{
″command″: {
″name″: ″prompt″, // Sets a prompt object
″system″: ″You are a weather assistant. Do not use more than 1000 words in the response.″,
″user″: ″{ f′I live in {location[′city_name′]}, {location[′region_name′]}. I am in the timezone
{location[′time_zone′]}. The following is the weather forecast: {′ ′.join(weatherData)}′ }″
}
}
]
},
″main″: { // Agent starts executing at the main task unit
″commands″: [
{
″command″: {
″name″: ″if″,
″condition″: ″{ not hasInit }″, // If this is a followup query, this won′t call init task unit again
″then″: [
{
″command″: {
″name″: ″func″,
″function″: {
″name″: ″init″
}
}
}
]
},
″hasInit″: true
},
{
″command″: {
″name″: ″prompt″,
″user″: ″{query}″ // Second user query is added to the prompt
}
},
{
″command″: {
″name″: ″Ilm″,
″profile″: ″anthropic″ // This agent calls a LLM configuration in this agent′s namespace called
′anthropic′. That configuration is set separately and it would specify the vendor, model and other
details.
},
″output″: ″{ result }″ // Write the output from the LLM to the output stream connected to a
second user GUI
}
]
}
}
}

Second agent specification has a similar purpose to the first agent. It is also a weather agent, but it is written using tool calling. It does not use a MCP server.

{
″agentVars″: {
″hasInit″: false
},
″functions″: {
″init″: { // init task unit is called only the first time this agent is executed in a conversation
″commands″: [
{
″command″: {
″name″: ″prompt″,
″system″: ″{ f′You are a weather assistant. Format the response with only plain text. Do not
use more than 200 words in the response.′ }″,
″user″: ″Answer the question below based on the local weather forecast. Local weather
forecast is available only within the USA. If the location is outside USA, return a message saying
that weather service is not available for that location.″
}
}
]
},
″getMyIP″: { // This task unit is used in tool calling, it must provide a description. It takes no
arguments and so it doesn′t set them
″description″: ″Gets the user′s IP address. Returns the IP address as a string.″,
″commands″: [
{
″return″: ″{ip}″
}
]
},
″getLocation″: { // This task unit is used in tool calling and it takes a single argument - userip
″description″: ″Gets the user′s location from their IP address. Returns a JSON object that includes
all the location details.″,
″args″: {
″userip″: {
″description″: ″IP address″,
″type″: ″str″
}
},
″commands″: [
{
″command″: {
″name″: ″api″,
″url″: ″https://api.ip2location.io″,
″params″: {
″ip″: ″{userip}″,
″key″: ″{secret(′IP2LOCATION_KEY′)}″
}
},
″return″: ″{ result if result[′country_code′] == ′US′ else ′Error: IP address not in USA. Only US
locations are supported.′ }″
}
]
},
″getWeather″: { // This task unit is used in tool calling and it takes two arguments: latitude and
longitude
″description″: ″Get the local weather from latitude and longitude of a location.″,
″args″: {
″latitude″: {
″type″: ″float″
},
″longitude″: {
″type″: ″float″
}
},
″commands″: [
{
″command″: {
″name″: ″api″,
″url″: ″{ f′https://api.weather.gov/points/{latitude},{longitude}′ }″
}
},
{
″command″: {
″name″: ″api″,
″url″: ″{ result[′properties′][′forecastHourly′] }″
},
″return″: ″{ [f′In {period[′number′]} hours: {period[′temperature′]} and
{period[′shortForecast′]}. ′ for period in result[′properties′][′periods′] }″
}
]
},
″main″: {
″commands″: [
{
″command″: {
″name″: ″if″,
″condition″: ″{ not hasInit }″,
″then″: [
{
″command″: {
″name″: ″prompt″,
″system″: ″{ f′You are a weather assistant. Format the response with only plain text. Do
not use more than 200 words in the response.′ }″,
″user″: ″Answer the question below based on the local weather forecast. Local weather
forecast is available only within the USA. If the location is outside USA, return a message saying
that weather service is not available for that location.″
},
″hasInit″: true
}
]
}
},
{
″command″: {
″name″: ″Ilm″,
″profile″: ″gemini″, // Use a LLM configuration in this namespace called ′gemini′.
″functions″: [ // List of functions (or tools in LLM terminology) that are available to be called.
LLM will tell a client module, which tool to call.
″getMyIP″,
″getLocation″,
″getWeather″
]
},
″output″: ″{ result }″
}
]
}
}
}

Third agent specification uses Hugging Face′ MCP server to answer questions about available AI models. It uses tool calling to send the right query to the MCP server.

{
″agentVars″: {
″hasInit″: false // Variable scoped at the agent level
},
″functions″: {
″init″: { // init task unit is called only the first time this agent is executed in a conversation
″commands″: [
{
″command″: {
″name″: ″prompt″,
″system″: ″Use the best tools to answer the question. Format your response as a pure text
but with nice indentation.″
}
}
]
},
″main″: {
″commands″: [
{
″command″: {
″name″: ″if″,
″condition″: ″{ not hasInit }″,
″then″: [
{
″command″: {
″name″: ″prompt″,
″system″: ″Use the best tools to answer the question. Format your response as a pure text
but with nice indentation.″
}
}
]
},
″hasInit″: true
},
{
″command″: {
″name″: ″prompt″,
″user″: ″{ query }″
}
},
{
″command″: {
″name″: ″Ilm″,
″profile″: ″anthropic″,
″mcp″: [ // Provides MCP tools that are available to the LLM. In this case, we are passing a
single tool.
″hf.hub_repo_search″ // hf is a MCP client configured in this namespace. hub_repo_search
is a tool in that MCP server.
]
},
″output″: ″{ result }″
}
]
}
}
}

Fourth agent is an orchestrator agent. It shows how a namespace can customize query matching to suit its requirements.

{
″agentVars″: {
″input_queries″: [ ],
″processing_query″: 0
},
″functions″: {
″getQueries″: {
″commands″: [
{
″command″: {
″name″: ″prompt″,
″promptName″: ″splitterPrompt″,
″system″: ″You are an expert in corporate systems and understand the corporate users and
their IT requirements. I have many corporate systems. Split the request into multiple steps, where
each step would typically be served by a single corporate system. Just give me each step as a
question on a single line. Do not include anything else in the answer as I will parse this directly.″,
″user″: ″{query}″
}
},
{
″progress″: ″Splitting query into individual steps″,
″command″: {
″name″: ″Ilm″,
″promptName″: ″splitterPrompt″,
″profile″: ″gemini″
},
″query_steps″: ″{ result.get_text( ).splitlines( ) }″,
″progress1″: ″{ f′Query steps: {query_steps}′ }″,
″input_queries″: ″{ [[q, ′not_started′] for q in query_steps] }″,
″processing_query″: 0
}
]
},
″iterateQueries″: {
″commands″: [
{
″command″: {
″name″: ″for″,
″iter″: ″{ enumerate(query_steps[processing_query:]) }″,
″loopVar″: [
″query_index″,
″aquery″
],
″do″: [
{
″command″: {
″name″: ″search″,
″query″: ″{ aquery }″,
″tags″: ″corporate″
},
″progress″: ″{ f′Matched query \\′{aquery}\\′ with agent {result[0]}′ }″
},
{
″progress″: ″{ f′Running agent {result[0].get(′agentTitle′)} for query \\′{aquery}\\″ }″,
″command″: {
″name″: ″invoke″,
″agentName″: ″{ result[0].get(′agentName′) }″,
″inputs″: {
″query″: ″{ aquery }″,
″userInputs″: ″{ userInputs }″
},
″agentVersion″: ″{ result[0].get(′agentVersion′) }″
},
″processing_query″: ″{ query_index + 1}″,
″userInputs″: { }
},
{
″input_queries″: [ ],
″processing_query″: 0
}
]
}
}
]
},
″summarize″: {
″commands″: [
{
″command″: {
″name″: ″prompt″,
″system″: ″You are an expert in corporate systems and understand the corporate users and
their IT requirements. I have collected information from multiple systems. Use all that and answer
the question.″,
″user″: ″{ query }″
}
},
{
″progress″: ″Ran all the agents..summarizing the result″,
″command″: {
″name″: ″Ilm″,
″profile″: ″openai″
},
″output″: ″{ result }″
}
]
},
″main″: {
″commands″: [ ]
}
}
}

1. A system comprising: a first set of one or more processors and a first memory coupled to the first set of processors comprising instructions executable by the first set of processors, the first set of processors being operable when executing the instructions to:
create a data storage service, a search engine module, a creation module, and an execution module;
and the creation module to process a request to create an artificial intelligence agent (agent), comprising:
receiving an agent specification wherein the agent specification is in a machine-readable, textual format comprising:
an agent name;
a set of one or more task units wherein each task unit comprises:
a task name; and
an ordered list of one or more command units wherein each command unit comprises an ordered list of fields, the fields comprising at least one field selected from among a command field, an action field, and a user-defined variable field, each user-defined variable field comprising a variable name and a variable value, the variable value comprising a constant value or a dynamic string;
and storing the agent name and the agent specification in the data storage service;
and the search engine module to process a request to index an agent, comprising:
receiving an agent descriptor wherein the agent descriptor comprises:
an agent name;
a description of the agent;
and indexing the agent descriptor and mapping it to the agent name;
and the execution module to process a request to search for agents comprising:
receiving a search query and one or more inputs wherein each input comprises a key and a value;
forwarding the request to the search engine module;
receiving, from the search engine module, an agent name matched to the forwarded request;
retrieving an agent specification corresponding to the agent name from the data storage service; and
returning the agent name and the agent specification.

2. The system of claim 1 additionally comprising: a second set of one or more processors and a second memory coupled to the second set of processors comprising instructions executable by the second set of processors, the second set of processors being operable when executing the instructions to:
create a client module;
and the client module to process a search request comprising:
receiving a search query and one or more inputs wherein each input comprises a key and a value;
sending the search query and inputs to the execution module and receiving an agent name and an agent specification;
creating a conversation state object in the second memory;
executing the agent specification comprising:
executing a task unit named main in the agent specification comprising:
executing each command unit in the task unit sequentially in the order in which the command unit occurs wherein executing a command unit comprises:
executing each field in the command unit in the order in which the field appears wherein
executing a command field comprises executing the command; and
executing an action field comprises taking the corresponding action; and
executing a user-defined variable field comprises evaluating a variable value comprising evaluating a constant or evaluating a dynamic string and assigning the evaluated variable value to a first value; and
when the user-defined variable has agent-level scope,
storing the first value in the conversation state object in association with the agent name and the variable name of the user-defined variable; and
storing the conversation state object in the data storage service by sending the conversation state object to the execution module.

3. The system of claim 2, wherein evaluating a user-defined variable field comprises evaluating a string value by determining whether the string value is enclosed within a designated delimiter, using the string value as a constant string value when the string value is not enclosed within the designated delimiter, and evaluating content within the designated delimiter as a language expression in an agent execution context when the string value is enclosed within the designated delimiter, wherein an evaluated result of the language expression replaces the string value and is not limited to a string value, and wherein, when an allowlist is used, the allowlist determines which native-language objects, functions, methods, modules, constants, runtime variables, command results, and context objects are available to the language expression.

4. The system of claim 2, wherein executing a command unit comprises executing one or more action fields included in the command unit, wherein each action field causes the client module to perform a predefined action, and wherein the predefined action comprises terminating a loop, skipping to a next loop iteration, returning from an execution scope, terminating execution of the agent successfully, terminating execution of the agent with an error, displaying a progress message, emitting trace information, writing a log message, or streaming or otherwise providing an output part generated by the agent to a user interface.

5. The system of claim 2 wherein executing a command field comprises executing a prompt command that defines or modifies a prompt object stored in the conversation state object, the prompt object comprising a name and an ordered list of prompt elements, wherein, when the prompt object is already stored in the conversation state object, executing the prompt command adds user prompt content to the existing prompt object, and wherein the prompt object is accessible by a plurality of agents during a same conversation such that prompt content added by a first agent is available to a second agent when the second agent generates a request to a large language model using the prompt object.

6. The system of claim 2, wherein executing a command field comprises executing a database command, wherein executing the database command comprises determining database connection information from a database connection profile or a connection string specified by the database command, evaluating a SQL statement specified by the database command, executing the SQL statement against a relational database management system using the database connection information, receiving a set of rows returned by the SQL statement, and assigning the set of rows to a runtime variable for use by a later command unit.

7. The system of claim 2, wherein executing a command field comprises executing a search command, wherein executing the search command comprises evaluating a query parameter and a tag parameter specified by the search command, searching for one or more agents matching the query parameter and the tag parameter using the search engine module, generating search results comprising an ordered list of matching agents ranked by search relevance, and assigning the search results to a result variable.

8. The system of claim 2, wherein executing a command field comprises executing an invoke command, wherein executing the invoke command comprises identifying an invoked agent using an agent parameter specified by the invoke command, executing the invoked agent in a same conversation as a calling agent using the conversation state object, streaming output produced by the invoked agent to a user interface, and assigning a value returned by the invoked agent to a result variable.

9. The system of claim 2, wherein the conversation state object comprises a conversation identifier, one or more agent run records, one or more prompt objects, one or more conversation variables, one or more agent variables, and additional input information, wherein each agent run record identifies an execution of an agent in a conversation, wherein the one or more prompt objects are shared within the conversation, wherein the one or more conversation variables are shared across agents in the conversation, and wherein the one or more agent variables are stored separately for different agents in the conversation.

10. The system of claim 9, wherein a first agent executes for a first user query in the conversation and updates at least one of the one or more prompt objects or the one or more conversation variables in the conversation state object, and wherein a second agent executes for a follow-up user query in the conversation using the updated conversation state object, such that the second agent uses information produced during execution of the first agent without the first agent being coded to call the second agent and without the second agent being coded to call the first agent.

11. The system of claim 2, wherein executing a command field comprises executing a systemLLM command that makes one or more task units of the agent specification available to a large language model as one or more callable tools, wherein the client module receives a tool call from the large language model identifying one of the one or more task units and one or more arguments, invokes the identified task unit using the one or more arguments, receives a task unit result from the identified task unit, and provides the task unit result to the large language model.

12. The system of claim 2, wherein executing a command field comprises executing a systemLLM command that makes one or more tools provided by a configured Model Context Protocol (MCP) server available to a large language model as one or more callable tools, wherein the client module comprises an MCP client, and wherein the client module receives a tool call from the large language model identifying one of the one or more tools provided by the configured MCP server, sends the tool call to the configured MCP server using the MCP client, receives a tool result from the configured MCP server, and provides the tool result to the large language model.

13. The system of claim 2, wherein an agent is associated with one or more groups, wherein each group is an access-control attribute, and wherein the search engine module compares the one or more groups associated with the agent with one or more groups associated with an end user and prevents the agent from being included in search results or prevents the agent from being executed when the end user is not associated with a required group.

14. The system of claim 2, wherein an agent is associated with one or more tags, wherein each tag is a classification attribute, and wherein the search engine module uses the one or more tags to filter agents in response to a search request.

15. The system of claim 2, wherein an agent is marked as an orchestrator agent, and wherein, when the client module receives the search request, the client module executes the orchestrator agent with the search query.

16. The system of claim 2, wherein the creation module stores an unvalidated agent specification as a draft in a private area of the data storage service, wherein the execution module validates the draft by checking the draft for one or more compile errors or one or more security violations, wherein the creation module publishes the draft as a published agent only after validation succeeds and after the client module executes the draft in a validation mode to completion without errors, and wherein the search engine module indexes an agent descriptor for the published agent only after the draft is published.

17. The system of claim 2, wherein the execution module records large language model usage events during execution of agents by the client module, each large language model usage event comprising a model identifier, an agent identifier, an invoking user, a token usage amount, and an execution time, and wherein the execution module generates a large language model usage report by calculating an estimated cost from the token usage amount using pricing information configured for the model identifier and aggregating the large language model usage events by model, agent, user, tenant, or time period.

18. The system of claim 2, wherein the execution module validates an agent specification before execution by parsing an expression contained in a dynamic string, generating or processing an abstract syntax tree for the expression, checking the abstract syntax tree against permitted node types or permitted operations, and rejecting or transforming a node or operation that is not permitted before the agent specification is executed.

19. The system of claim 2, wherein the client module enforces one or more runtime controls during execution of an agent specification, the one or more runtime controls comprising a maximum agent runtime, a maximum number of loop iterations, a maximum application programming interface response size, a maximum number of rows returned or processed by a database call, or a runtime upper bound checked by a safe function that implements a rewritten operator.

20. The system of claim 2, wherein the execution module provides an interface for generating an agent specification from a natural language description, wherein the execution module provides the natural language description to a large language model with information describing an agent specification language and one or more resources available to agents in the system, receives from the large language model a generated agent specification that conforms to the agent specification language, and validates the generated agent specification before storing the generated agent specification in the data storage service.
